(19) United States
(12) Patent Application Publication
(10) Pub. No.: US 2018/0181900 A1
(43) Pub. Date: Jun. 28, 2018

(54) COMPUTER-IMPLEMENTED SYSTEM AND METHOD FOR PROCEDURAL COMPLIANCE

(71) Applicant: Check-6 International Inc., Tulsa, OK (US)

(72) Inventor: GUY HUGGINS, KENNEDALE, TX (US)

(21) Appl. No.: 15/856,765

(22) Filed: Dec. 28, 2017

Related U.S. Application Data
(60) Provisional application No. 62/439,534, filed on Dec. 28, 2016.

(51) Int. Cl. G06Q 10/06

(52) U.S. Cl. CPC G06Q 10/06395; H04L 67/10

(57) ABSTRACT

The invention generally relates to a computer-implemented system, and method for its use, for facilitation of procedural compliance with critical tasks, including the use of a computer having an interactive compliance application that enables both computer algorithm implemented checklists and human-aided checklists for procedural discipline and verifiable compliance in normal, emergency and work instruction situations. The computer is coupled for intercommunication to a plurality of stations or clients from which respective authorized users each have a browser-based interface with the computer.

### BACKGROUND OF THE INVENTION

### 1. Field of the Invention

This invention generally relates to computer-implemented compliance systems and their methods of use.

### 2. Description of the Related Art

Failure to comply with intended procedures is a common concern for many industries. Companies commit significant resources to develop detailed procedures; yet, often they are not actively used by the workforce as part of their daily routines or fade over time. Reasons for failure to comply with procedures are myriad, including: voluminous paper procedures are not easily transported to the worksite and are difficult to reference; latest version of the procedure is not distributed or in use; critical lessons learned are not incorporated; companies rely on experience alone instead of using crosschecks to mitigate human factors; and procedures are authored by office personnel who lack operational perspective.

Built around an operation's most critical tasks, checklists become the heartbeat of any healthy organization helping competent crews perform with step-by-step precision. Checklists make the manner in which tasks are performed predictable, and provide management the ability to verify compliance in order to assure crew safety and productivity. However, investments in initiatives such as Lean or Six Sigma processes tend to lose their impact over time due to the inability to monitor and enforce compliance with refined and improved processes. Therefore, a system and process is needed to preserve a company's investment in such programs while building employee confidence in management's initiatives as managers and crews begin to experience shared successes.

It is therefore desirable to provide a computer-implemented compliance system and method for facilitation of procedural compliance with critical tasks.

It is further desirable to provide an interactive computer-implemented compliance system and method that gives users the tools to respond with methodical actions and reactions in normal and emergency situations, includes those that may require additional detail and supporting references available through work instructions.

It is further desirable to allow this system to be used offline in such a manner that multiple users can log into and out of the same mobile device and that checklist assignments, initiation, completion, and other actions by each users will be tracked for compliance and performance purposes when the data is synchronized to a central server at a later time when online.

It is still further desirable to provide a computer-implemented compliance system and method that captures operational compliance and performance data to enable users to proactively assess the sources and magnitude of waste before they negatively impact quality, cost, safety or the customer experience, unlike auditing software that tracks lagging indicators.

It is yet further desirable to provide a computer-implemented compliance system and method that ensures every critical checklist step has an action, so that supervisors and workers find a consistent workflow during high-risk operations.

It is still yet further desirable to provide a computer-implemented compliance system and method that identifies and develops checklists for critical tasks most susceptible to Lost Time Incidents (LTIs), Total Reportable Incident Rates (TRIR), downtime, flat time, and Non-Productive Time (NPT) and mitigates occurrences of safety-related issues through embedded notes, cautions, and warnings (that may require acknowledgement by the user) to unite safety and operations at the time and location of task performance.

It is still yet further desirable that all work stoppages be qualified as well as being quantified and that temporal performance be reported in multiple granular formats so that baseline and future performance efficiency can be accurately assessed: 1) individual step time to complete, 2) individual and total pause time with associated reason(s), 3) total checklists time to complete, and 3) total checklist operation time (i.e. total time to complete minus total pause time).

It is still yet further desirable to provide a computer-implemented compliance system and method that facilitates compliance by providing a procedural crosscheck to ensure positive outcomes. Because the system and process captures both who performed what steps when and the relevant data at a granular level, the compliance system ensures procedural compliance and accountability that is easily verifiable.

It is still yet further desirable to provide a computer-implemented compliance system and method that timely feedback to users enabling them to: monitor critical aspects of workforce performance and compliance using the leading indicators; identify and eliminate your main sources of inefficiency, variance and waste which typically go unqualified or quantified (such as rework, work stoppages, non-productive time, flat time, etc.); develop baseline trends; identify areas for leadership, team, and process improvement; assess quality; and/or manage, measure and maintain the impact of process improvements.

It is still yet further desirable to provide a computer-implemented compliance system and method where critical steps are simplified, actions are deliberate, and all checklist execution data is captured and tracked for reporting purposes.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, the invention relates to a computer-implemented, interactive compliance system and process that facilitates real-time operational task performance and data capture with an explicit operational focus. The system and process provide culture-driven initiative with an intuitive checklist-based computer implementation for procedural discipline and verifiable compliance. The system and process seamlessly integrates into an organization's existing crew resource management strategy, giving end users a higher level of reliability and human error mitigation. Based on an aviation-style checklist development structure, the system and process ensures every critical checklist step has an action, so that supervisors and workers find a reliable and consistent workflow during high-risk operations.

The interactive compliance system and process helps organizations: simplify complex procedures where tasks require an action and response; mitigate the distractions that cause critical mistakes; prepare for the task with easily searchable and linkable references; communicate clearly so everyone is on the same page; focus on the task at hand by managing the amount of information necessary for good; decision-making; preserve valuable information while eliminating unnecessary paperwork; minimize human error; verify compliance and track success metrics demonstrating that checklists are completed accurately and in a timely manner; improve safety and key performance indicators by tracking performance metrics; and/or stay in control with instant updates that can be disseminated across the enterprise.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 illustrates Primary Domain Objects in accordance with an illustrative embodiment of the invention disclosed herein;

FIG. 2 illustrates Transport Domain Objects in accordance with an illustrative embodiment of the invention disclosed herein;

FIG. 3 illustrates Enterprise Service application layers in accordance with an illustrative embodiment of the invention disclosed herein;

FIG. 4 illustrates a process flow of registering Enterprise Managers with Event Manager in accordance with an illustrative embodiment of the invention disclosed herein;

FIG. 5 illustrates a process flow of publishing Enterprise Managers as an Event in accordance with an illustrative embodiment of the invention disclosed herein;

FIG. 6 illustrates a process flow of an incoming Package workflow in accordance with an illustrative embodiment of the invention disclosed herein;

FIG. 7 illustrates a process flow of uploading a Channel to the Server in accordance with an illustrative embodiment of the invention disclosed herein;

FIG. 8 illustrates a process flow of the Server routing an uploaded Package in accordance with an illustrative embodiment of the invention disclosed herein;

FIG. 9 illustrates a process flow of destination processing of the Package in accordance with an illustrative embodiment of the invention disclosed herein;

FIG. 10 illustrates a process flow of a Channel reconciling an uploaded Transport Package in accordance with an illustrative embodiment of the invention disclosed herein;

FIG. 11 illustrates a process flow of a Channel polling the Server in accordance with an illustrative embodiment of the invention disclosed herein;

FIG. 12 illustrates a process flow of the Channel download from the Server in accordance with an illustrative embodiment of the invention disclosed herein;

FIG. 13 illustrates a process flow of the Channel processing the Package in accordance with an illustrative embodiment of the invention disclosed herein;

FIG. 14 illustrates a process flow of starting processes performed on the Server Host in accordance with an illustrative embodiment of the invention disclosed herein;

FIG. 15 illustrates a process flow of Server hosted processes in accordance with an illustrative embodiment of the invention disclosed herein;

FIG. 16 illustrates a process flow of Tenant discovery in accordance with an illustrative embodiment of the invention disclosed herein;

FIG. 17 illustrates a process flow of curating Server data into Packages in accordance with an illustrative embodiment of the invention disclosed herein; and

FIG. 18 illustrates a process flow of scavenging Transport Packages from ESFS in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

As used herein, the term “organization” or “enterprise” refers to a group of two or more individuals with some relationship to one another. These relationships may be legal, such as in the cases of corporations, partnerships, associations, employees, collaborators, and the like, or these relationships may be informal, such as among a group of individuals seeking to work together to optimize results (e.g., investigators seeking to collaborate on a forensic research project).

As used herein, the term “computer” may refer, but is not limited to a laptop or desktop computer, or a mobile device, such as a desktop, laptop, tablet, cellular phone, smart phone, personal media player (e.g., iPod), wearable computer, implantable computer, or the like. Such computing devices may operate using one or more operating systems, including, but not limited to, Windows, MacOS, Linux, Unix, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media players, portable digital assistants, tablet computers, wearable computers, implanted computers, and laptop computers.

As used herein, the term “user” may refer, but is not limited to someone affiliated with a client organization who interacts with the interactive compliance system through a computer for purposes of using the interactive compliance system's functionality, such client users may include, but are not limited to, employees, agents, affiliates, partners, and contractors of the organization.

As used herein, the term “compliance checklist” may refer, but is not limited to a set of and/or sequence of questions or decisions and resulting options and actions where a response to a question or decision may determine the next question, option or action.

As used herein, the term “domain objects” may refer, but is not limited to information regarding communications, actions, decisions, results, and other data and processes related to the interactive compliance system's operations and functions.

As used herein, the term “reliable” means predictable leading to a consistent, desirable result.

The interactive computer-implemented compliance system is enabled to facilitate of procedural compliance with critical tasks by implementing interactive checklists. The interactive compliance system facilitates procedural discipline and verifiable compliance in normal, emergency and work instruction situations by integrating computer analysis with human decision-making to improve results, reporting and efficiency of decision-making processes. The interactive compliance system utilizes digital checklist authoring, execution, and reporting features that provide ease-of-use and verifiable compliance and performance tracking. Operational data is captured by users at the time and place of task performance in order to critically assess performance, develop baseline trends, identify areas for improvement, assess quality, and measure the impact of process improvements. The computer-implemented compliance system captures accurate data at the time a particular task or job is performed, thereby generating insight into aspects of performance that drive safety, quality, cost, and profitability in contrast to lagging indicators though auditing of processes or work after they have been completed. The system and method provide a means to document work completion using photos or videos to prove the quality of work being performed. In addition, the interactive computer-implemented compliance system utilizes granular data to precisely determine the inputs that have the greatest effect on outcomes and develop impactful process improvements. The system provides temporal details to facilitate process variance and waste analysis by qualifying and quantifying the frequency, source, and impact of work stoppages for every interactive checklist that are critical to discover the main sources of waste and variance though a requirement to enter a reason every time a checklist is paused. The interactive compliance system unites operations and safety at the time and place of task performance unlike independent risk analyses and hazard reviews, and can require explicit acknowledgement of a note, warning, or caution before completing a step.

The computer-implemented system differentiates between operationally focused checklists (minimum critical information and steps to act as a crosscheck) and work instructions (which are used to perform more complex processes or those that require additional resources). The computer-implemented interactive checklist-type labeling allows rapid checklist location and initiation of digital checklists to respond facilitate reliable performance to time-critical actions.

The interactive compliance system may employ one or more of the following techniques and strategies: (1) establishing bi-directional electronic communication between system elements, such elements providing information, displaying output, soliciting input, accepting input, processing data, or the like; (2) allocating tasks among system elements; (3) creating and implementing interactive decision checklists, which may be accomplished by one or more computers, by one or more human operators, or by a combination of one or more computers and one or more human operators and may involve the integration of rules, regulations, laws, policies, and similar parameters into decision checklists; (4) making records of domain objects, including records of communications, actions, decisions, results, and other data and processes related to the system's operations and functions; (5) communicating and coordinating with other software systems, such software systems including but not limited to enterprise systems, such as Lean or Six Sigma systems and processes, data storage systems, and the like; (6) analyzing compliance checklist data; (7) displaying and reporting compliance checklist data and analyses of compliance checklist data in text and graphical forms, including by use of a data visualization component or dashboard; (8) providing reminders and prompts that may or may not be integrated with calendar and task software and that may involve the generation of emails, text messages, and other forms of electronic communication; (9) translating and/or transcribing audio and/or text from one language into one or more other languages or data formats, including both human languages and computer languages; (10) collecting, processing, distributing, analyzing and otherwise interacting with multimedia elements, such elements possibly including digitally-stored documents, images, and sounds; (11) establishing and implementing iterative feedback loops, which may enable or facilitate the use of data related to past activity (e.g., records of communications, actions, decisions, and results) to be used in determining future actions; and (12) facilitating the submission of user-generated improvement suggestions to capture and formalize best practices.

The compliance system may involve multiple computers in multi-directional electronic communication with one another, such that a client user of one such computer may enter a query and receive a response using that computer, which may be a mobile device, such as an iPhone, iPad, Android Phone, or the like. Similarly, a computer that is part of the interactive compliance system may send an inquiry to one or more client user devices, which may respond to the inquiry.

The compliance system may allocate tasks to system elements. Similarly, the interactive compliance system may allocate a complex calculation to a computer with sufficient processing power and memory to perform the calculation quickly, and generate the analytic result (e.g., Lost Time Incidents (LTIs), Total Reportable Incident Rates (TRIR), downtime, flat time, and Non-Productive Time (NPT)).

The interactive compliance system may record all compliance checklist data, such that the times and locations of all actions, queries, responses, decisions, results, and other data and processes related to the interactive compliance system's operations and functions are recorded. Such data may be recorded locally on client users' computers, such as mobile devices, then transmitted to servers or other repositories where the data may be stored, processed, aggregated, and analyzed.

The interactive compliance system may display checklist data and analyses of checklist data in text and graphical formats, including through the use of a data visualization component or a dashboard. Such displays may also be distributed through email, by text message, or in other formats. Such displays may be interactive, allowing users to click on displayed elements, to rotate, zoom in, change color, focus on a data subset, create new data sets, create new charts from existing data sets, compare data sets, and the like.

The compliance system may provide reminders and prompts that may or may not be integrated with calendar and task management software. Such reminders and prompts may be initiated in accordance with a set schedule, generated based on computer algorithms, or be generated by users. Such reminders and prompts may be communicated as on-screen messages or displays, sounds, videos, emails, text messages, multimedia messages, and other forms of electronic communication.

The interactive compliance system may have functionality for establishing and implementing iterative feedback loops, which may modify algorithms and compliance checklists based on system data recorded and processed.

The compliance system may include an interactive compliance application that may be available through web sites, on mobile devices, or some other client device type that is capable of operating or displaying a digital application. The iOS version of an interactive compliance application may be developed as a native application for iPhone, iPod, and iPad enablement. The interactive compliance system may also include an administration application that allows administrators to perform various functions, which may include managing users, policies, rules, and content of the interactive compliance application. Such administrative application may be hosted on the web, may be deployed as part of an internal company network as a web application, and may be available as a Cloud service.

The invention generally relates to a computer-implemented, interactive compliance system, and method for its use, for facilitation of procedural compliance with critical tasks for procedural discipline and verifiable compliance in normal, emergency and work instruction situations. Although the invention is described with reference to specific block diagrams, and table entries, etc., it will be appreciated by one of ordinary skill in the art that such details are disclosed simply to provide a more thorough understanding of the invention. It will therefore be apparent to one skilled in the art that the invention may be practiced without these specific details.

In embodiments, all information passed between components will be in the form of a Plain old Class (or CLR) object (referred to as “POCO” classes) representing the state of domain objects, which requires a conversion of a dataset(s) into objects as soon as they are read from a data store, so that those objects can be shared and used. The domain objects described herein are those domain objects taken from the compliance baseline application, and limited to only those objects involved in a sync operation between the client application and the compliance system server.

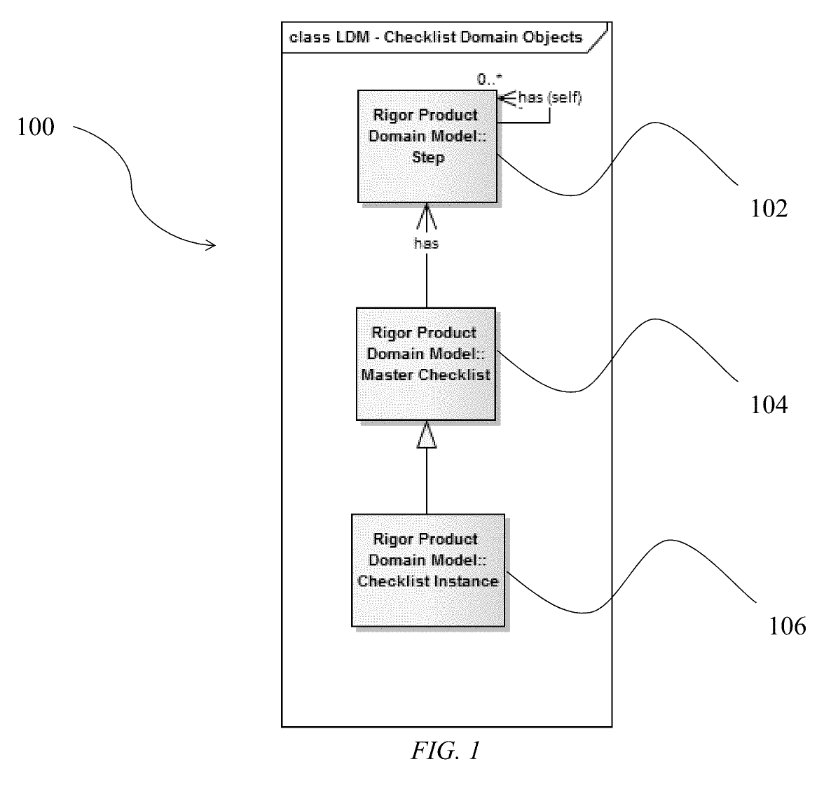

Referring now to FIG. 1, the primary domain objects 100 for compliance system are the Master Checklist (“Checklist”) 104, the Checklist Instance (“Assigned Checklist”) 106, and Step (“Checklist Step” and “Assigned Checklist Step”) 102. Each Checklist Instance 106 is a copy of a Master Checklist 104 that is “assigned” to a user for execution. The vast majority of all other domain objects are associated to these three primary objects. Checklist Instances 106 that have been cancelled or completed are considered “static”, as they are no longer being actively executed.

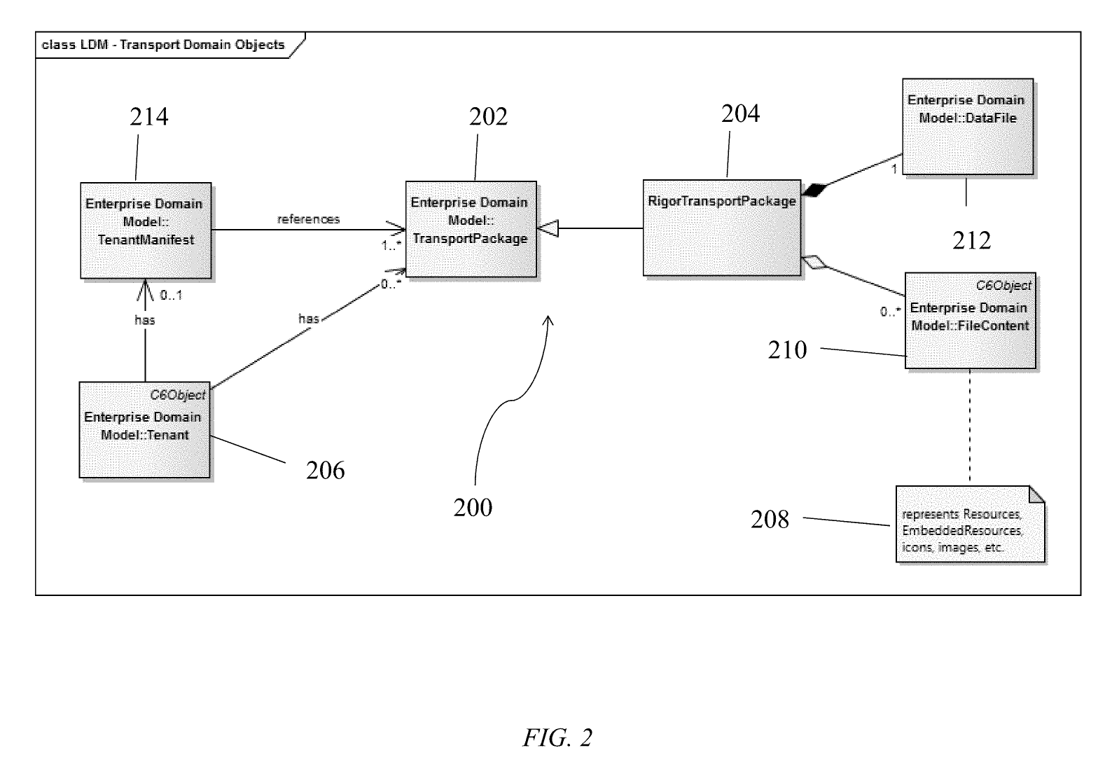

Referring now to FIG. 2, transport domain objects 200 include the Transport Package 204, the Data File 212, the File Content 210, the Tenant Manifest 214 and the Tenant 206, each as defined below. The Transport Package 202 is container of a Data File 212 and potentially multiple File Contents 210. Each Transport Package 202 will contain the contents of a single data integrity group, which is a collection of domain objects and files that belong together. Examples of data integrity groups are Checklist Instances 106 and Master Checklists 104. The Data File 212 contains all the data for a data integrity group, which is typically harvested from an OLTP data store. The File Content 210 represents any file associated with a checklist or checklist step. For example, a photo taken during the execution of a checklist, or a PDF document used by the checklist user as reference material for executing a checklist. The Tenant Manifest 214 is a listing of all Transport Packages 202 available on the Enterprise Server for a Tenant 206. Each Transport Package 202 referenced by the Tenant Manifest 214 will be stored in the file store, awaiting transport to a Channel. Each Transport Package 202 reference should contain all of the data needed by the Channel to a) discern its need for that package, and b) be able to download it. The Tenant 206 represents an owner of enterprise and/or product data, which is typically a client user. For example, the Tenant 206 is realized as a “Client” in the system baseline. Each “Client” has its own system Data Store, but has records in the master system data store.

Data Integrity Groups represent a collection of business objects that must be transported and processed as a single unit to maintain the integrity of the collection itself. Data Integrity Groups are maintained on both the Channel (for upload to the Enterprise Server), as well as on the Enterprise Server (to make available to Channel.)

Data Files 212 are constructed on the iOS Channel, using data harvested from the local iOS Channel data store. The Deleted_ChecklistInstances_[ChannelID]_[GMT Stamp] Data File 212 references all local Checklist Instances 106 with a status of deleted. These are sent to the server to be marked as “deleted”, then sent to all Channels so they also can also mark them as “Deleted” (should require only references to each Checklist Instance, not the whole Checklist Instance). The Favorites_[ChannelID]_[GMT Stamp] Data File 212 references all favorites to be flagged on the server, and shared with other Channel. When a User uses another Channel device, they should see their favorites after a sync is successful, which should require only references to each Master Checklist 104 and the User, not the whole Master Checklist 104 and User. The Suggestions_[ChannelID]_[GMT Stamp] Data File 212 contains all Suggestions, which should require the full data for each Suggestion, but only a reference to the User and Master Checklist 106. The ChecklistInstance_[ChecklistInstance ID]_[ChannelID]_[GMT Stamp] Data File 212 is for each Checklist Instance 106 for which it, or any of its associated domain objects, are sync candidates. One Data File 212 will be created per Checklist Instance 106. Data can be full or partial, depending on the rules and circumstances on the Channel at the time the data is harvested. In all the Data Files 212 detailed above, the [GMT Stamp] should represent the moment the Data File 212 was created.

The following Data Files 212 are constructed on the Enterprise Server, using data harvested from the Web API. Partial Data Files are constructed on a periodic basis by an Enterprise Server process, and should only contain that data which has been added or modified in the intervening period. Partial Data Files will “build up” on the ESFS. The PartialMasterData_[GMT Stamp] Data File 212 contains recently added/updated (since last harvest) User, Department, Hazard, MetaDataGroup, MetaTag, Favorite domain objects that placed into a single Data File 212. The PartialMasterChecklist_[MasterChecklist ID]_[GMT Stamp] Data File 212 contains recently added/updated (since last harvest) Master Checklist 104 objects, for which they, or any of their associated domain objects, are sync candidates. Each MasterChecklist 104 should be in its own Data File 212. The PartialDeletedChecklists_[GMT Stamp] contains recently added/updated (since last harvest) Master Checklist 104 and Checklist Instance 106 domain objects that have been placed in a “Deleted” state. The PartialChecklistInstance_[Checklist Instance ID]_[GMT Stamp] Data File 212 contains recently added/updated (since last harvest) Checklist Instance 106 objects, for which they, or any of their associated domain objects, are sync candidates. Each Checklist Instance 106 should be in its own Data File 212.

Holistic Data Files 212 are constructed on a periodic basis by an Enterprise Server process, and should contain all of the data that exists in the system. Each instance will replace the previous. The AllMasterData_[GMT Stamp] Data File 212 contains all User, Department, Hazard, MetaDataGroup, MetaTag, Favorite domain objects, which are placed into a single Data File 212. The AllMasterChecklist_[MasterChecklist ID]_[GMT Stamp] contains all Master Checklist 104 objects, for which they, or any of their associated domain objects, are sync candidates. Each Master Checklist 104 should be in its own Data File 212. The AllDeletedChecklists_[GMT Stamp] contains all Master Checklist 104 and Checklist Instance 106 objects that have been placed in a “Deleted” state. The AllChecklistInstance_[Checklist Instance ID]_[GMT Stamp] contains all Checklist Instance 106 objects, for which they, or any of their associated domain objects, are sync candidates. Each Checklist Instance 106 should be in its own Data File 212. In all the Data Files 212 detailed above, the [GMT Stamp] should represent the moment the Data File 212 was created.

The following Transport Packages 202 are constructed on the iOS Channel, acting as containers for system's data integrity groups. These Transport Packages 202 include the Deleted_ChecklistInstances_[ChannelID]_[TenantID]_[GMT Stamp], Favorites_[ChannelID]_[TenantID]_[GMT Stamp], and Suggestions_[ChannelID]_[TenantID]_[GMT Stamp] Data Files 212. The Checklist Instance_[ChecklistInstance ID]_[ChannelID]_[TenantID]_[GMT Stamp] contains the Data File 212, and all Resources 208 created during the execution of the Checklist Instance 106 (pictures taken that belong to the checklist itself, its Steps, or other associated domain objects.) Because this Transport Package 202 may contain one or more files, it has the potential to be large, and therefore a long-running transfer. In all the Transport Packages 202 detailed above, the [GMT Stamp] should represent the moment the Transport Package 202 was created.

The following Transport Packages 202 are constructed on the Enterprise Server, acting as containers for system data integrity groups. These Transport Packages 202 include PartialMasterData_[TenantID]_[GMT Stamp] Transport Package 202, the PartiaIDeletedCheckslists_[TenantID]_[GMT Stamp] Transport Package 202, the AllMasterData_[TenantID]_[GMT Stamp] Transport Package 202 and the AllDeletedChecklists_[TenantID]_[GMT Stamp] Transport Package 202, each of which contain the respective Data File 212. The Transport Packages 202 also include the PartialMasterChecklist_[MasterChecklist ID]_[TenantID]_[GMT Stamp] Transport Package 202 that contains all Resources 208 created for a single Master Checklist 104 (pictures/files that belong to the checklist itself, its Steps, or other associated domain objects), the PartialChecklistInstance_[ChecklistInstance ID]_[TenantID]_[GMT Stamp] Transport Package 202 that contains all Resources 208 created for a single Checklist Instance 106 (pictures/files that belong to the checklist itself, its Steps, or other associated domain objects), the AllMasterChecklist_[MasterChecklist ID]_[TenantID]_[GMT Stamp] Transport Package 202 that contains all Resources 208 created for a single Master Checklist 104 (pictures/files that belong to the checklist itself, its Steps, or other associated domain objects), and the AllChecklistInstance_[Checklist Instance ID]_[TenantID]_[GMT Stamp] Transport Package 202 that contains all Resources 208 created for a single Checklist Instance 106 (pictures/files that belong to the checklist itself, its Steps, or other associated domain objects). Because the PartialMasterChecklist, the PartialChecklistInstance, AllMasterChecklist and the AllChecklistInstance Transport Packages 202 may contain one or more files, they have the potential to be large, and therefore a long-running transfer. In all the Transport Packages 202 detailed above, the [GMT Stamp] should represent the moment the Transport Package 202 was created. Moreover, the “AllMasterData” Transport Package 202 has the potential to become very large, as more and more Users are added to the Tenant 206.

Each Tenant 206 in the Enterprise can potentially have a Tenant Manifest 214, which contains references to all of the Transport Packages 202 currently available to Channel of that Tenant 206. Each Transport Package 202 record will contain: it's unique ID (the ID of the Transport Package 202, as referenced in the ESDS (optional). If the system keeps references to Transport Packages 202 in the ESDS, then this alone can be used to identify the file), a file name as it exists in the ESFS (used by the Channel when requesting the Transport Package 202), a GMT Stamp of the time it was written to the ESDS (can be used by both the server and Channel as a temporal business rule filter. For example, the Channel may only request Transport Packages 202 created since the last time it performed a sync operation), the ID of the Channel that created/uploaded it (will be null for server-created Transport Packages 202, and can be used by both the server and Channel as a business rule filter. For example, the server may filter a request for the Tenant Manifest 214 by removing all of the references to Transport Packages 202 created by the Channel making the request. Will be null for those Transport Packages 202 originating from the Enterprise Server), the Channel Type ID the Transport Package 202 is for (in this case iPad implementation, and can be used by both the server and Channel as a business rule filter. This value allows us to specify that a Transport Package 202 may target one or more Channel Types), and the Application Type ID the Transport Package 202 is for (can be used by both the server and Channel as a business rule filter. This value allows us to specify that a Transport Package 202 may target one or more Application Types).

The Physical Data Model describes the data stores, and their storage schema, for all domain objects, as well as all ancillary objects. The physical data model for all enterprise data stores should be expressed as a script, that can be versioned, and executed on the target data store technology.

An Enterprise Server File Store (ESFS) 302, accessible to all Enterprise Servers, will include the following configurable structure: Data\Database used to keep the file representing the Enterprise Server Data Store (ESDS); Data\Incoming Transport Packages 202 where all Channel uploaded Transport Packages 202 are written to before being routed; Data\Unknown\Incoming Transport Packages 202 that is the store for those uploaded Transport Packages 202 for which routing could not be discerned; Data\System\Incoming Transport Packages 202 where all system-destined Transport Packages 202 are written for processing; Data\System\Outgoing Transport Packages 202 where all system Transport Packages 202 and system Sync Reconciliation Data (RSRD) are written for sharing to iOS Channel.

If necessary, the Enterprise Server will persist domain object states into a transactional database, known as the Enterprise Server Data Store (ESDS), which will respect third normal form. The ESDS must be accessible to all Enterprise Server nodes to accomplish horizontal scalability.

All published events will be written to the Enterprise Server Event Sink (ESES) 304. The ESES 304 must be accessible to all Enterprise Server nodes to accomplish horizontal scalability. In the event that the process hosting the ESES 304 should go down, or be terminated deliberately, all of the events in the sink must remain persisted, so that they can be “rehydrated” and processed after the host process comes back up. In other words, the ESES 304 must support survivability.

Shared Cached items, such as the Tenant Manifest 214, will be maintained in the Enterprise Server Cache (ESC) 310, available to all Enterprise Servers.

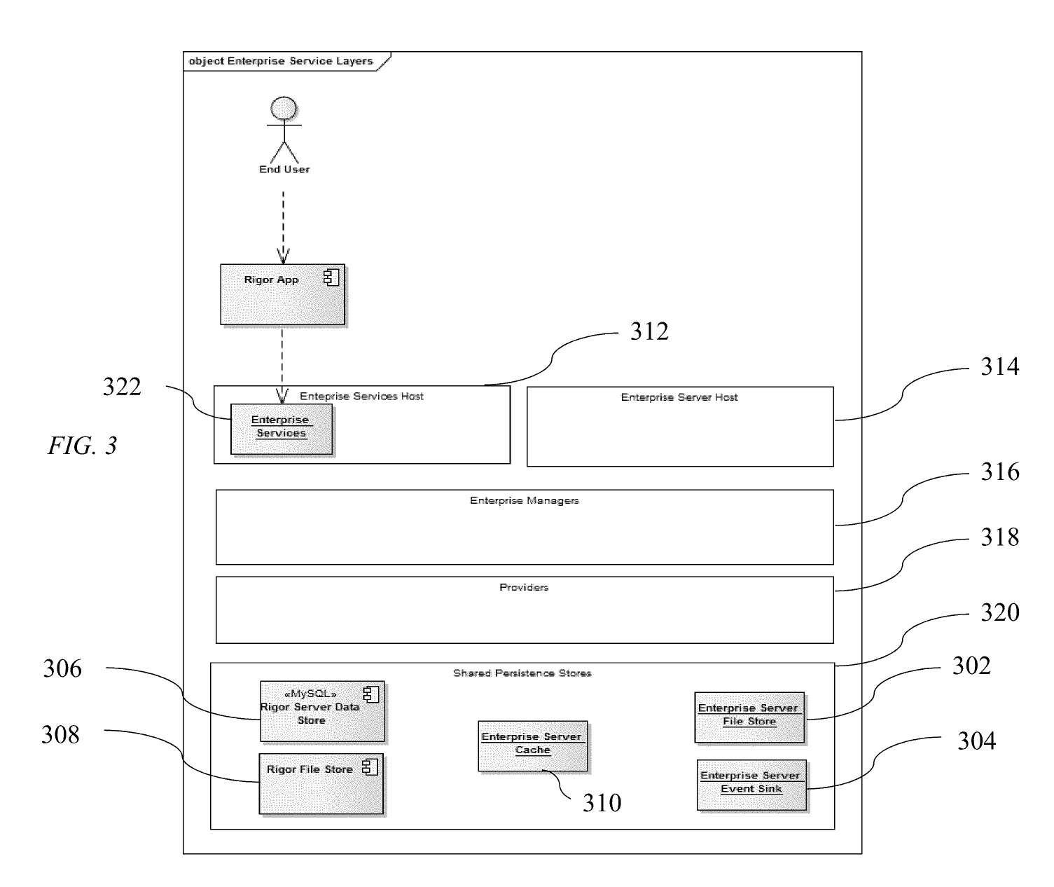

Referring now to FIG. 3, the computer-implemented compliance system will have an application architecture that is implemented with four distinct “layers”, each with its own purpose. An Enterprise Services Host 312 and an Enterprise Server Host 314 execute all Enterprise Server functionality, and all services, including Enterprise Services 322, are hosted at this layer. An Enterprise Manager 316 represents an enterprise capability, fully encapsulated, and generally decoupled from all other Enterprise Managers 316. An Enterprise Manager 316 represents the “brains” of the enterprise, and will contain all of the business logic needed to perform its enterprise function. However, it may or may not natively provide 100% of that functionality; depending on the functionality it needs, it may use one or more Providers 318. A Provider 318 is used by an Enterprise Manager 316 to execute commodity functionality that is typically already available in a client artefact. The Shared Persistence Stores 320 contains all necessary data stores, file stores and memory caches that will be accessed, and shared across multiple Enterprise Servers. In all cases, the information being passed between the “layers” is one or more domain business objects, which represent the “common currency” of the enterprise. Finally, the implied call stack should allow a distinct service operation to maintain transactional integrity from the top to the bottom, providing “all or nothing” capabilities to those operations that require it.

Enterprise Services 322 are hosted by the Enterprise Services Host 312, and consumed by the iOS Channel. They represent the “front door” to all enterprise functionality, and are implemented by select Enterprise Managers 316. In other words, select operations on select Enterprise Managers 316 will be exposed to Service Consumers via the façade of a service endpoint. Each service will be responsible for both authenticating and authorizing each request made. All services will remain backwards compatible to themselves to ensure that all fielded consumers continue to enjoy a consistent user experience. If a business situation develops and the administrator decides to deprecate a service, it will be phased out with full awareness and participation from the user base.

Enterprise Managers 316 are the components that provide functionality to both the Enterprise Server Host 314 and the Enterprise Services Host 312. Because they are reused across both processes, they create economies of scope. All Managers 316 should favour asynchronous operation; however, there will be use cases where synchronous operations will be desired, so this must be accommodated, but done so through the judicious use of abstraction.

Enterprise Managers 316 will be judiciously deployed within binaries to maximize deployment flexibility, and reduce the chances for regression. Binaries will be discovered by the host process (via the future Load Profile), loaded and invoked, when the host process starts up. Upon being invoked each Manager 400 needs to register itself with the Event Manager 400, making the Event Manager 400 aware of all the Events 404 and to which they subscribe. To realize asynchronous processing, each Manager 400 will subscribe 406 to one or more Events 404 that are raised by Managers 400 themselves, or other components of the system. In these cases, the publisher will publish 502 an Event 404 to the Event Manager 400, who has the responsibility of relaying that Event 404 to the appropriate subscribers. Each Manager 400 that subscribes to events will process those Events 404 as they are published. Each Manager 400 implements Enterprise Manager 316, which describes the required operations that all Enterprise Managers 316 must support.

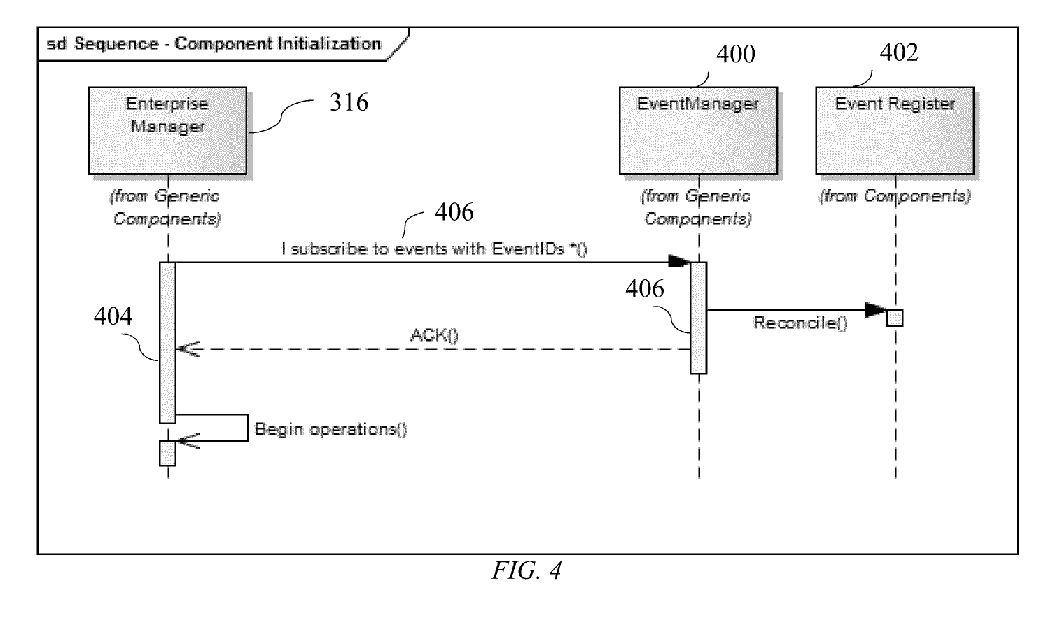

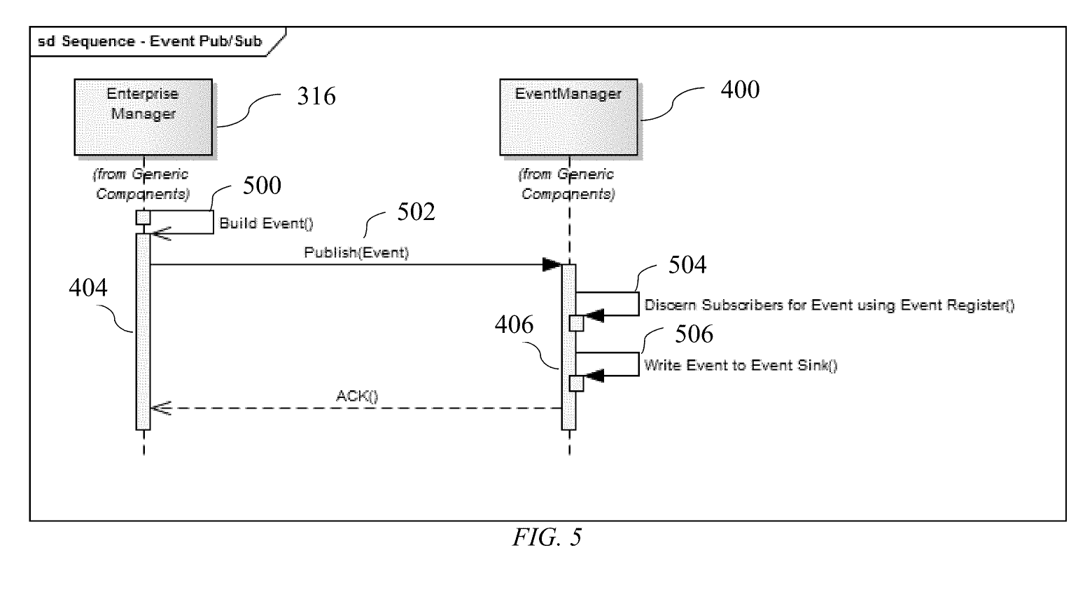

Referring now to FIGS. 4 and 5, each Manager 316 contains the business logic needed to perform all of their operations. These operations should be performed asynchronously, unless there is a compelling use case for synchronous operation. For asynchronous operations, the Manager 316 will publish 502 an Event 404 (ether a subscribed Even (406) or a built Event (step 500)) to the Event Manager 400, who is responsible for republishing the Event 404 into the appropriate subscribing Manager or Managers 400 (step 504). Events 404 that have been published, but not handled will reside in the Enterprise Server Event Sink 304 (step 506). Like the various persistence stores, the ESES 304 will be accessible to all Enterprise Server instances, allowing the Managers 316 across multiple servers access to all published Events 404. This horizontal scaling enables processing across multiple server instances, thus increasing performance.

Providers 318 represent commodity functionality, and are typically realized in existing third-party components. Providers 318 can make use of third-party libraries, the .NET framework, native OS services, as well as Internet or Cloud-based services. Providers 318 are used by Enterprise Managers 316 when the Manager 316 needs the functionality the Provider 318 specializes in. Because they are reused by Mangers 316 running across both processes, they create economies of scope.

Each Provider 318 will consist of at least two layers. The “top” layer will be exposed to the Manager 316, and should contain the core operations and all the business logic of the Provider 318. On initialization, each Provider 318 should accommodate retrieving configuration information from a configuration file. The “bottom” layer will be the “dumb” worker component that performs the functionality of the Provider 318, and will most likely be realized as a third-party binary.

To illustrate this concept of a layered Provider 318, consider the example of a Package Handler (a Manager) 316 processing a Transport Package 202. The Package Handler's business logic determines that the Transport Packages 202 contents should be persisted to a data store. The Package Handler 316 would use the Datastore Provider 318 to accomplish the persistence task, without having any knowledge of how the Datastore Provider 318 actually works. Upon receiving instructions from the Package Handler to persist the contents into the store, the Provider 318 then would determine to use a Web API component to persist the contents of the system. The Package Handler has no awareness of what the Provider 318 is doing, nor how it is being done. The Web API “bottom” layer components are invisible and completely abstracted from the Package Handler, which only has awareness of the “top” layer of the Provider 318. This abstraction is critical, as it places the awareness of, and responsibility for, all Provider 318 functionality on the Provider 318 itself, and not the Package Handler.

Each Provider 318 will implement the Provider 318 interface, which governs those operations every Provider 318 must support. Providers 318 will be judiciously deployed within binaries to maximize deployment flexibility, and reduce the chances for regression.

The enterprise sync capability should be implemented in a way to be leveraged by other applications, providing economies of scope across the enterprise. The content whose data integrity must be guaranteed will be transferred and processed as a single unit (Transport Package 202), and the transfer mechanisms will be network aware, capable of using what bandwidth is available, as well as being robust enough to pause and resume transfers. The capability may not be implemented as a single, long-running operation, and each side of the sync can implement this capability in separate, disconnected asynchronous processes.

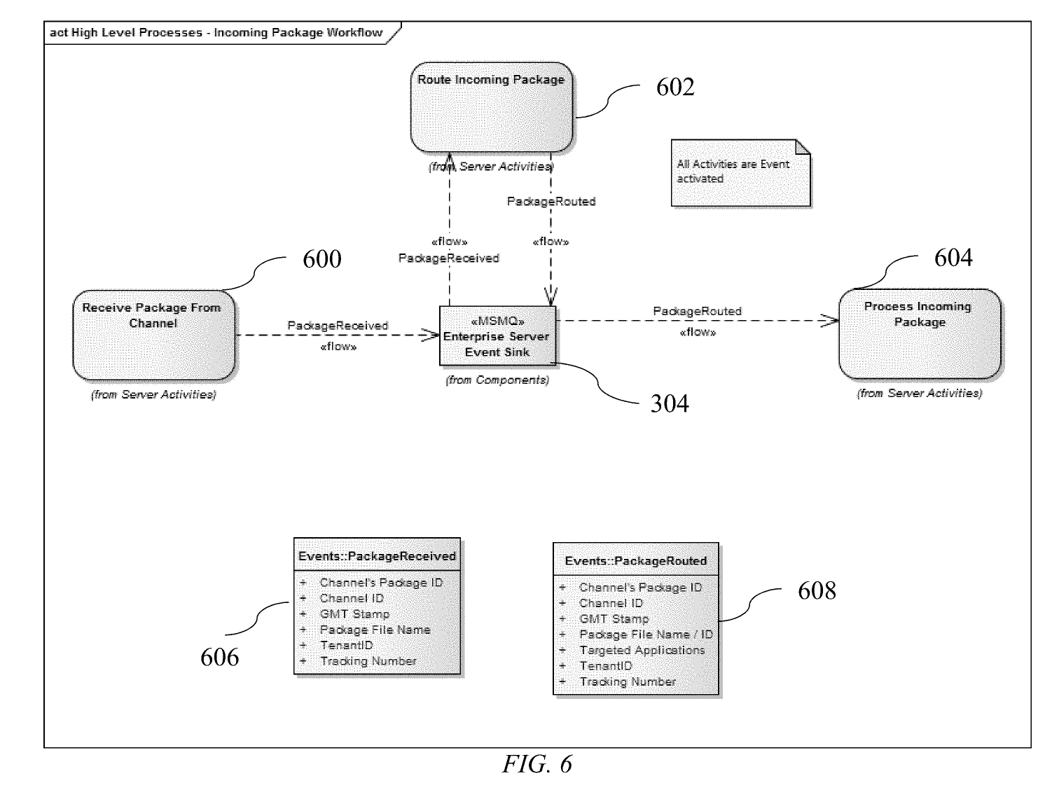

Referring now to FIG. 6, the architecture of the computer-implemented compliance system may be broken down into distinct activities, including receive Package from Channel 600. The PackageRecieved Event 606 is routed Incoming Package 602 through the ESES 304. The PackageRouted Event 608 is processed Incoming Package 604, and iOS Channel reconciles Uploaded Transport Packages 202. The iOS Channel polls the Enterprise Server, transports the Transport Packages 202 from Enterprise Server, and processes the Package 202.

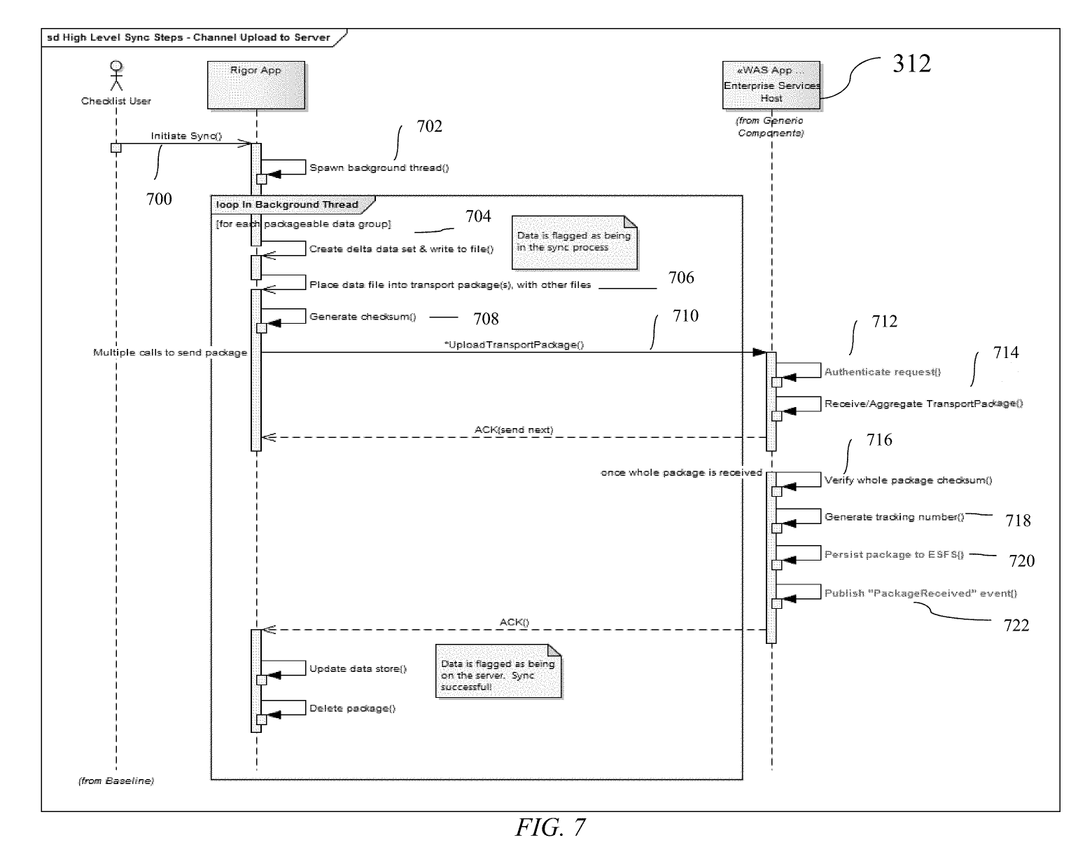

FIG. 7 illustrates the synchronization steps for a Channel upload to the Server. If Enterprise Server node is completely unavailable, the Channel's request to UploadTransportPackage would time out, and the Channel would be responsible for failing gracefully. If the system API was unavailable, the Enterprise Server would not be able to authenticate the request, and would respond to the Channel with a 500 response, with an appropriate message, and the Channel would be responsible for failing gracefully. If the ESFS 302 were unavailable, the service would be unable to persist the incoming Transport Package 202, and would respond to the Channel with a 500 response, with an appropriate message, and the Channel would be responsible for failing gracefully. If the ESES 304 were unavailable, the service would be unable to publish the “PackageReceived” event, and would respond to the Channel with a 500 response, with an appropriate message, and the Channel would be responsible for failing gracefully. The Enterprise Server would also delete the received Transport Package 202 from the ESFS 302, lest it be orphaned.

All synchronization will be initiated by the iOS Channel, in response to User input 700. All sync operations on the iOS Channel will occur in a background thread(s) 702, and not the user interface thread, so that the user can continue working. However, depending on the functional requirements, there may be limitations to the data the User can work with, if that data is involved in an active sync operation.

Candidate sync data will be a) all data for the domain objects that need to be shared with other Channels, and b) have been created or updated since the last successful sync. All candidate data will be grouped for data integrity purposes, and written into Data Files 212 using the baseline file format.

Data Files 212 will be written to the iOS Channel file store (704), waiting to be placed into Transport Packages 202 for transport to the Enterprise Server. Only after the Data File 212 is successfully created, can the iOS Channel update the candidate data, in the ESFS 302, in a way to indicate that it is currently involved in the sync process, ruling it out as a sync candidate until the current sync process is completed. Data Files 212 are created by aggregating the harvested data by data integrity groups.

Asynchronously, each Data File 212, and any associated Content Files 210, is placed into a corresponding Transport Package 202 (706), and the Transport Package 202 is written to the iOS file store 308, waiting for eventual transport to the Enterprise Server. Once the Transport Package 202 is successfully written to the file store 308, the Data File 212 will be deleted, as it is no longer needed.

After each Transport Package 202 is created, the iOS Channel will generate a checksum for it (708). Once the checksum is generated, the iOS Channel will call the Enterprise Server's “UploadTransportPackage” method (710) passing the following parameters: Authentication information; Tenant ID; Channel ID; the Channel's ID for the Transport Package 202; Checksum for the Transport Package 202 (if final request of a multi-request); and Transport Package 202 contents.

This upload operation must be capable of supporting the following: if the upload fails, network connectivity is lost, or the User shuts down the application, it should resume the upload at the point of last success; and the iOS Channel should tune the upload according to network conditions in real time (712). When the Channel first determines to send a Transport Package 202, it will make a calculation, dividing the available bandwidth (in megabits) by the size of the Transport Package 202 (in megabits). If it determines that the entire Transport Package 202 cannot be sent at once, it can be broken into distinct “chunks”, and each chunk sent independently (714).

After the Transport Package 202 is successfully and fully received (716), the Enterprise Server will respond with an acknowledgement, containing server-generated Tracking Number (718); the Channel's ID for the Transport Package; and a GMT Stamp of when the Transport Package was successfully received 404. After receiving this acknowledgment, the iOS Channel will update its internal data store to indicate that the domain objects contained in the Transport Package 202 were successfully received on the Enterprise Server, and delete the Transport Package 202.

The returned Tracking Number will be used by each Channel to reconcile the ID's it generated, to the IDs the Enterprise Server creates upon persisting the business objects to the system Data Store 306 (720). This server-created reconciliation data will reference the Tracking Number, so each Channel can retrieve it using the same Tracking Number. This information will enable each Channel to “close the loop” for each Transport Package 202 it uploads to the Enterprise Server. In the event that the transport operation fails on the Enterprise Server, the response with be an acknowledgement, indicating that the upload failed, and provide the reasons for the failure. Finally, in the event that the sync enters an unforeseen, and perhaps untraceable state, it needs to support the User cancelling the sync operation.

Each channel's request to the Upload Transport Package method will be authenticated by checking the “Authorization” header of the request for the appropriate information. If authentication fails, an HTTP 500 response will be created and returned to the channel, with the content {“error”:“Unauthenticated User” }.

Once a Transport Package 202 has been holistically received, the checksum will be verified on the Enterprise Server. If the checksum is not verified, an HTTP 500 response will be created and returned to the channel, with the content {“error”:“Checksum Not Verified” }, and the Transport Package 202 will be discarded. If the checksum is verified, the Enterprise Server will generate an internal tracking number, and write the Transport Package 202 to the Enterprise Server File Store (ESFS) 302. If the tracking number generation fails, an HTTP 500 response will be created and returned to the channel, with the content {“error”:“Internal Tracking Number Not Generated” }. If the file write fails, an HTTP 500 response will be created and returned to the channel, with the content {“error”:“Storage of uploaded package failed” }. The Transport Package 202 will be written into the ESFS 302 at “Data\IncomingTransport Packages”.

After the Transport Package 202 is written to the ESFS 302 (720), the “PackageReceived” event should be published to the Enterprise Server Event Sink 304 (722). If the event is not successfully published, an HTTP 500 response will be created and returned to the channel, with the content {“error”:“Internal Server Error” }. Finally, after the “PackageReceived” event is published, a HTTP 200 response should be returned to the channel with the content {“tracking number”: [Internal Tracking Number]}

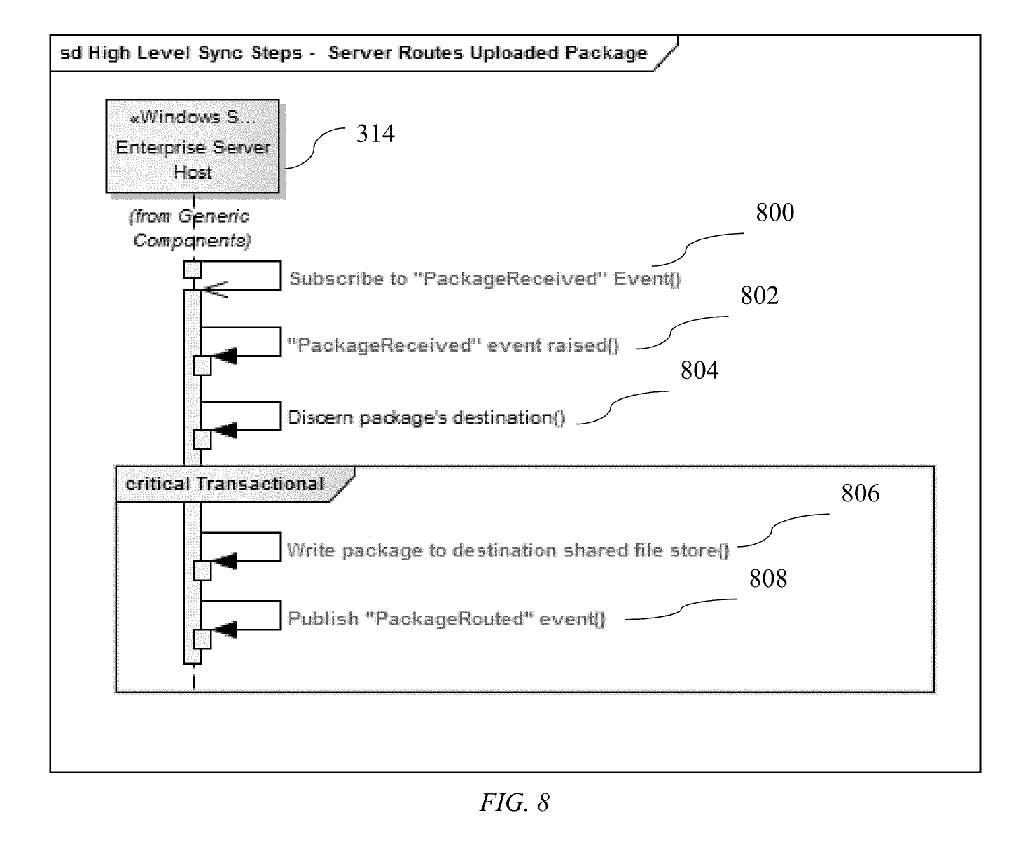

Referring now to FIG. 8, the Enterprise Server's Enterprise Server Host 312 will subscribe (800) to the “PackageRecevied” event upon initialization. When it receives a “PackageReceived” event (802), it will discern (804) the destination application for the Transport Package 202; within a transaction, move the Transport Package 202 (will know location via configuration) (806) and publish the “PackageRouted” event (808); routed Transport Package 202 will be written into the ESFS 302 at “Data\System\IncomingTransport Packages\[Tenant ID]”; in the event that the transaction fails, republish the original “PackageReceived” event; and in the event that the destination application cannot be discerned, move the package to Data\Unknown\IncomingTransport Packages, and publish the “PackageRoutingUndetermined” event.

If Enterprise Server node is completely unavailable, this process would not execute. Any “PackageReceived” events will remain safely in the ESES 304 (because they are persisted), waiting to be processed once the Enterprise Server comes back online. If the ESES 304 were unavailable, this process would not receive any “PackageReceived” events, and would simply remain idle, waiting for the ESES 304 to come back online. If the ESFS 302 were unavailable, the operation would be abandoned, and the “PackageReceived” event would remain in the ESES 304, to be processed again until successful. If the ESES 304 were unavailable at the end, the operation would be abandoned, and the “PackageReceived” event would remain in the ESES 304, to be processed again until successful. The Transport Package 202 would remain in the incoming ESFS 302, and removed from the routed ESFS 302.

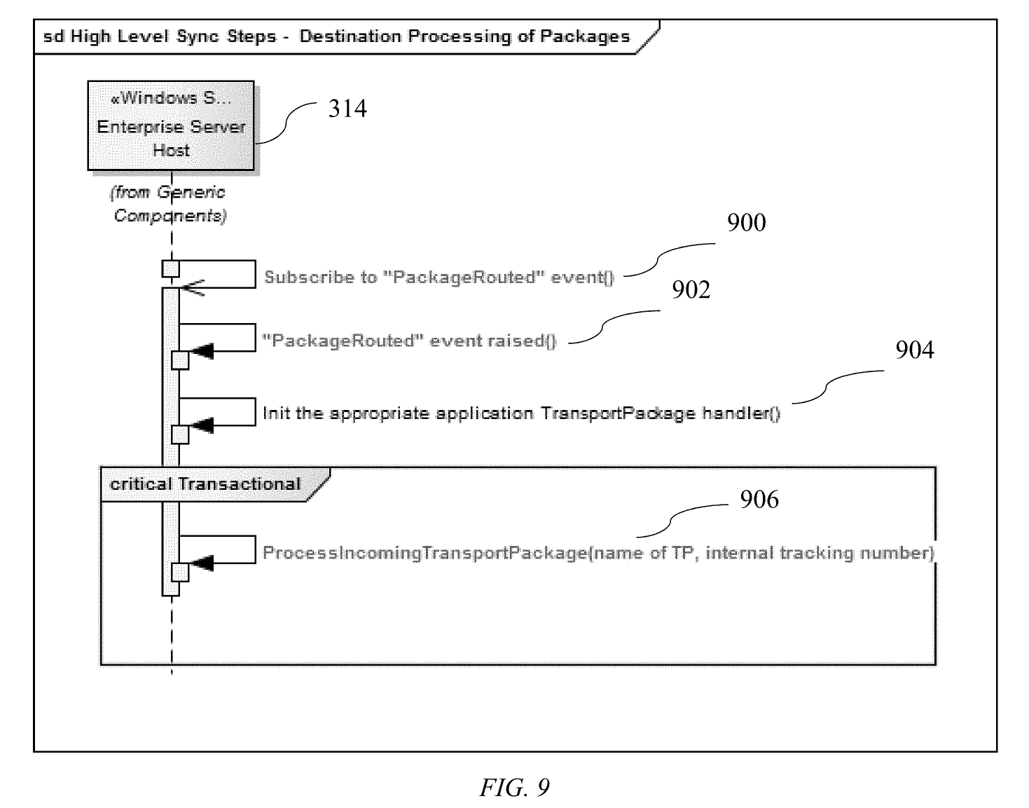

FIG. 9 illustrates the processing for incoming Packages 202. The Enterprise Server's Enterprise Server Host 312 will subscribe to the “PackageRouted” event upon initialization (900). When it receives a “PackageRouted” event (902), it will initialize (904), then execute the appropriate Application Transport Package Handler's “ProcessIncomingTransport Package” operation (906).

The Application Transport Package Handler will perform the following operations within the operational boundary of a managed transaction: unpack the Transport Package 202 (Handler will know where its file store is by configuration); read the Data File 212, and use its contents to update the appropriate data in the Data Store 306; parse the data into distinct calls to the baseline Web API, making full reuse of the existing services, including their native business rules, and DML execution. The has several advantages including a) reuse of the Web API which means the business rules do not have to be replaced, or persistence function, and b) the time saved helps ensure completion on-schedule. If an API call fails, it must be retried until it is successful.

Only after ALL API calls have been successfully made (via the “managed/artificial transaction”), perform the following within a transactional boundary but relating the ID's returned from the API calls to any ID's contained in the Transport Package's 202 Data File 212. Persist these relationships, along with the Tracking Number, and any other needed data, for future use by the Channel to reconcile the objects contained in uploaded the Transport Package 202. This system Sync Reconciliation Data (RSRD) will be used in a separate process for Channels to “close the loop” on their unique synchronization process. The File Content 210 is then moved to the appropriate place in the File Store 306, and the Transport Package 202 is deleted. In the event that multiple Channels upload a Transport Package 202 for the same data integrity group, all can be processed in the order received. This means that subsequently processed packages can result in changes to data from previously processed packages; however, reconciliation rules and functionality can be implemented to avoid this over righting scenario.

If Enterprise Server node is completely unavailable, this process would not execute, and any “PackageRouted” events will remain safely in the ESES 304, waiting to be processed once the Enterprise Server comes back online. If the ESES 304 were unavailable, this process would not receive any “PackageRouted” events, and would simply remain idle, waiting for the ESES 304 to come back online. If the ESFS 302, API or File Store were unavailable, the operation would be abandoned, and the “PackageRouted” event would remain in the ESES 304, to be processed again until successful.

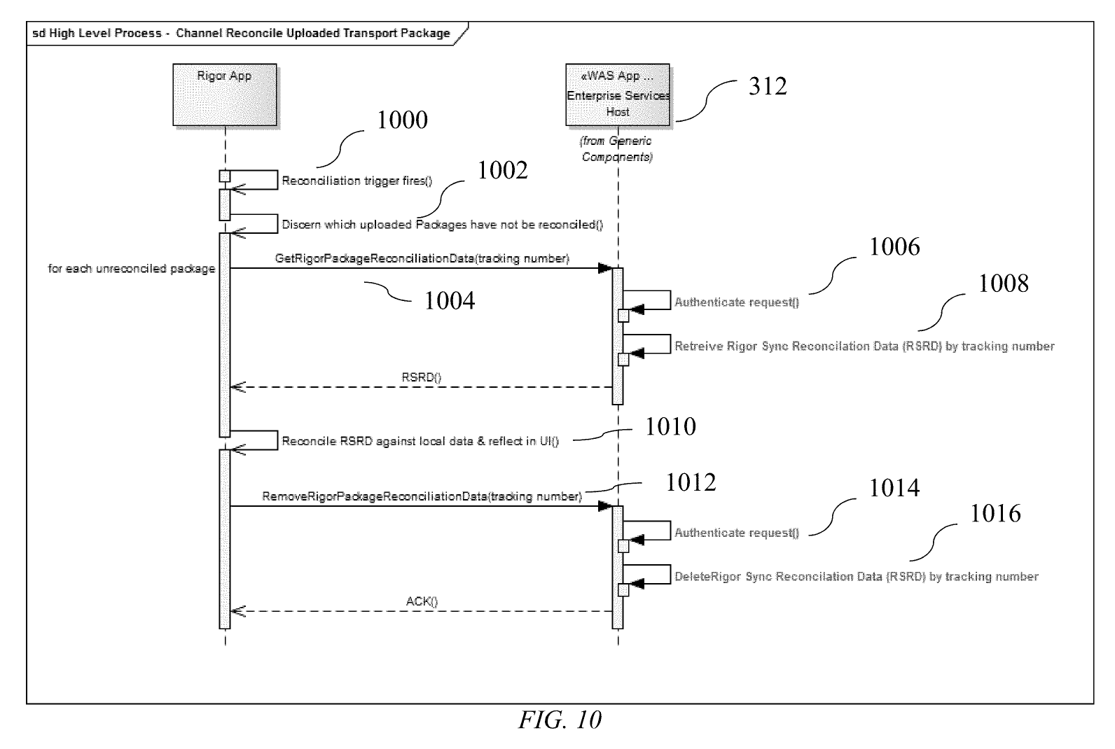

FIG. 10 illustrates the process in which the iOS Channel reconciles uploaded Transport Packages. The iOS Channel creates negative ID numbers for all domain objects created on the Channel itself. These numbers are used in the requests that the Channel makes to the baseline Server during the sync operation. The Server API synchronously persists Channel uploaded data into the Data Store, and returns the Data Store's positive IDs to the Channel in the synchronous response. The Channel uses these positive numbers to update those domain object records in its local database.

To accommodate this design using the Enterprise Synchronization capability, the following operations may be performed between the Channel and the Enterprise Server. The Channel creates a background routine for reconciling each Transport Package it has created and uploaded to the Enterprise Server. This background “reconciliation process” (1000) will execute, and upon triggering: reads the local Channel data store to discern all list of all the Transport Packages that have not been reconciled (1002); and the Channel will call the GetPackageReconciliationData service on the Enterprise Server (1004), for each of package, passing in the tracking number for the package that it received from the Enterprise Server when that package was originally uploaded.

The Enterprise Server will search for and retrieve the Sync Reconciliation Data (RSRD) (1008) and return it to the Channel. The Channel will use the RSRD to reconcile its server-created positive IDs to its own negative IDs, thus completing the full synchronization.

To remove the RSRD from the server, the Channel will call the RemovePackageReconciliationData service (1012), passing in the same tracking number it used to retrieve the RSRD (1014). The server deletes the RSRD (1016) and returns an acknowledgement to the Channel. At this point, both the Channel and the Server are aware that the Transport Package that corresponds with the Tracking Number has been fully synchronized.

At a minimum, the RSRD for each uploaded Transport Package should contain the tracking number of the package and the API generated positive ID for each Channel-provided negative ID.

If Enterprise Server node is completely unavailable, the Channel's request to GetPackageReconciliationData and RemovePackageReconciliationData would time out, and the Channel would be responsible for failing gracefully. If the API was unavailable, the ES would not be able to authenticate the request, and would respond to the Channel with a 500 response, with an appropriate message, and the Channel would be responsible for failing gracefully. If the ESFS 302 were unavailable, the ES would be unable to retrieve the RSDS, and would respond to the Channel with a 500 response, with an appropriate message, and the Channel would be responsible for failing gracefully. If the ESFS 302 were unavailable, the ES would be unable to delete the RSDS, and would respond to the Channel with a 500 response, with an appropriate message, and the Channel would be responsible for failing gracefully.

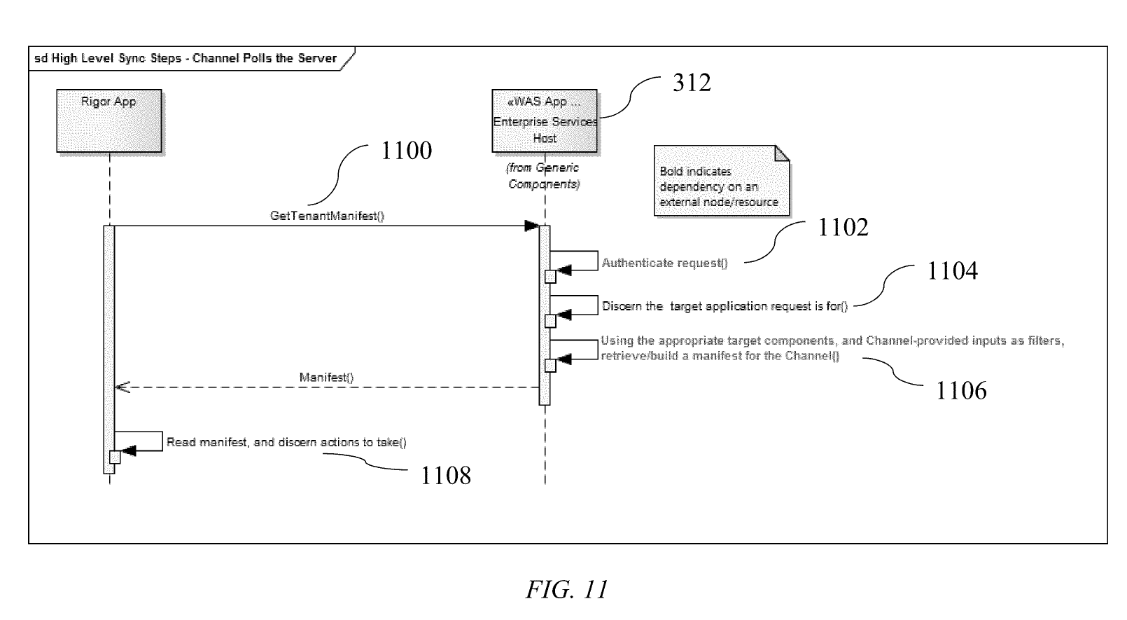

FIG. 11 illustrates the synchronization steps for the iOS Channel polling the Enterprise Server. All synchronization will be initiated by the iOS Channel, in response to User input. All sync operations on the iOS Channel will occur in a background thread(s), and not the UI thread, so that the user can continue working. However, depending on the functional requirements, there may be limitations to the data the User can work with, if that data is involved in an active sync operation.

If Enterprise Server node is completely unavailable, the Channel's request to GetTenantManifest would time out, and the Channel would be responsible for failing gracefully. If the API was unavailable, the ES would not be able to authenticate the request, and would respond to the Channel with a 500 response, with an appropriate message, and the Channel would be responsible for failing gracefully. If the ESC 310 were unavailable, the ES would be unable to retrieve the Tenant Manifest, and would respond to the Channel with a 500 response, with an appropriate message, and the Channel would be responsible for failing gracefully.

The iOS Channel will call the Enterprise Server's “GetTenantManifest” method (1100), passing in the following data parameters: authentication information; Tenant ID; Channel ID; and GMT of last successful request. This request should return a Tenant Manifest 214 listing of all the Transport Packages 202 available for that Tenant/Channel. Upon receiving the Tenant Manifest 214 as the response, the iOS Channel will read the contents, and reconcile to its own internal data store, determining for itself what items from that Tenant Manifest 214 it needs to retrieve from the Enterprise Server (1102).

Upon receiving a request to the “GetTenantManifest” method (1100), the Enterprise Server will discern that the request is for the application (1104). Once the application is discerned, the service will initialize, then execute the appropriate Application Tenant Manifest Builder's “GetTenantManifest” operation (in this case, the Tenant Manifest Builder), passing it the parameters received from the Channel. The Tenant Manifest Builder will retrieve the Tenant Manifest 214 from cache (if available), or construct a new one (then place into cache), then do any filtering of the Tenant Manifest 214 (1106). Potential filters include stripping out references to any Transport Packages 202 that came from the requesting Channel; stripping out references to any Transport Packages 202 older than the last request data. In this case, the Channel would need to provide the GMT stamp of its last successful request; and/or stripping out references to any Transport Packages 202 not intended for the authenticated User (1108).

After performing filtering, the service will return the filtered Tenant Manifest 214 in an HTTP 200 response to the iOS Channel. The Tenant Manifest 214, at a minimum, needs to contain an inventory of all the Transport Packages 202 available for the Tenant 206.

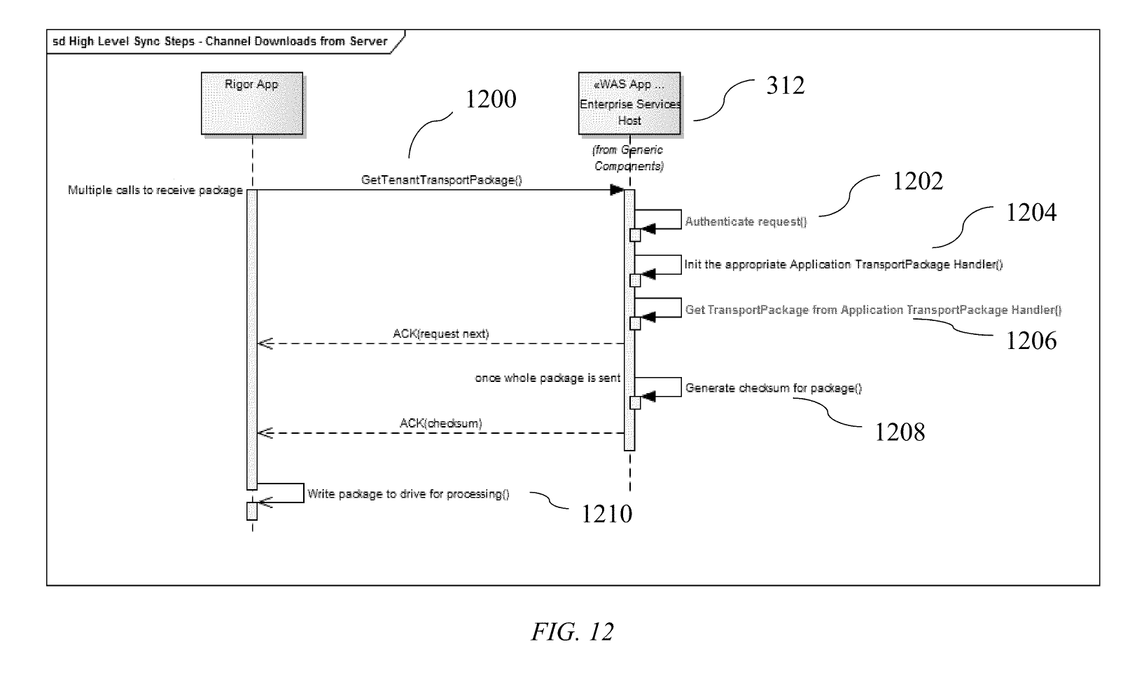

Referring now to FIG. 12, which illustrates the transport of Package 202 to the iOS Channel from Enterprise Server. If Enterprise Server node is completely unavailable, the Channel's request to GetTenantTransport Package would time out, and the Channel would be responsible for failing gracefully. If the API was unavailable, the ES would not be able to authenticate the request, and would respond to the Channel with a 500 response, with an appropriate message, and the Channel would be responsible for failing gracefully. If the ESFS were unavailable, the ES would be unable to retrieve the requested Transport Package, and would respond to the Channel with a 500 response, with an appropriate message, and the Channel would be responsible for failing gracefully.

After discerning those Transport Packages 202 it needs from the Tenant Manifest 214 (again, based upon its own business rules and data), the iOS Channel will call the Enterprise Server's “GetTenantTransport Package” method (1200) for each record, passing in the following data parameters: authentication information; Transport Package name/ID—used by the Enterprise Server to obtain the TP from the Tenant's folder in the outgoing file store; Tenant ID—used by the Enterprise Server to obtain the TP from the Tenant's folder in the outgoing file store; and Channel ID. The Enterprise Server will return the Transport Package 202 (may take multiple calls) (1204), and after the entire Transport Package 202 has been sent (1206), it will generate and return a checksum (1208). The iOS Channel will write the Transport Package 202 to its local file store for processing (1210).

When the Enterprise Server receives each request, it will discern who the application to request is for, and use that application's Transport Package Handler retrieve the Transport Package 202. It will respond to the requests with the Transport Package 202 (possibly over multiple calls). The final request should also return the generated checksum of the whole Transport Package 202. Only after the final response is sent, the Enterprise Server will publish a “PackageSent” event, with the following parameters: Tenant ID; Transport Package Name/ID; Channel ID; and/or GMT stamp. The “All” Transport Packages 202, created by the server, may be potentially locked while being overwritten by the Enterprise Server process. In these cases, the response will be delayed until the write is complete.

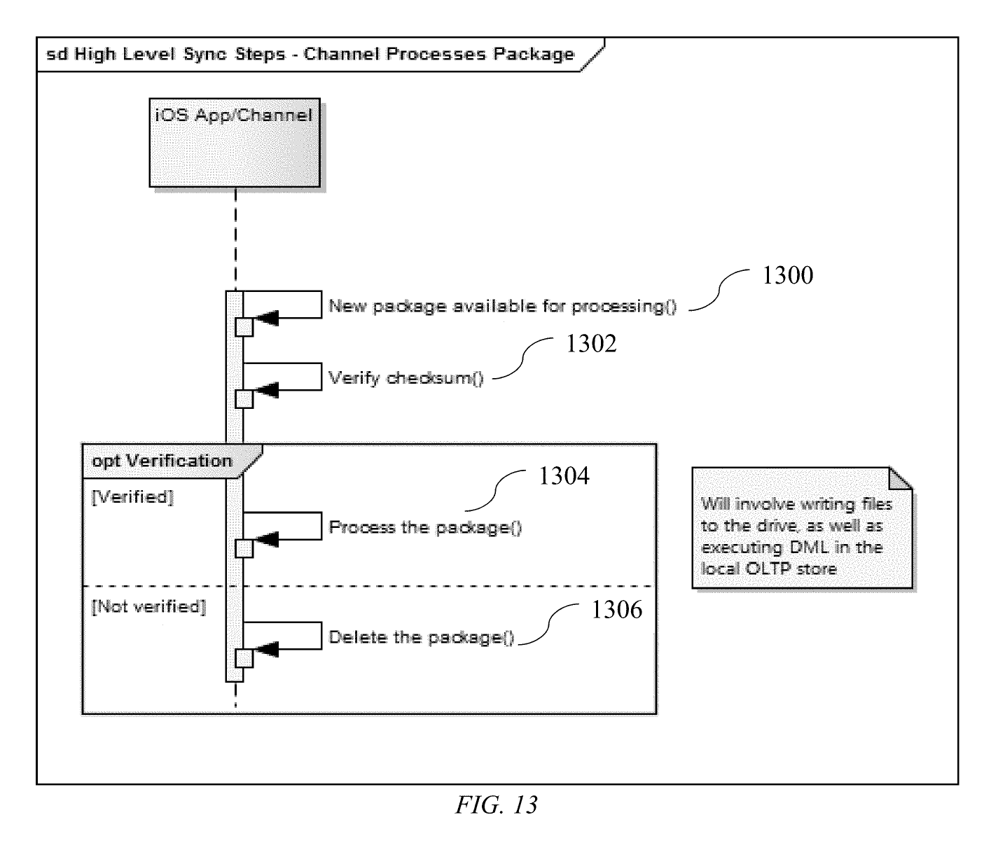

FIG. 13 illustrates the synchronization steps of how the iOS Channel processes a Package 202. The iOS Channel will verify the checksum of the newly arrived Transport Package 202 (1300) using the checksum provided by the Enterprise Server (1302). If the verification fails, the iOS Channel will delete the Transport Package 202 (1306). If the checksum is verified, the iOS Channel must reconcile the contents to its local data store and file store (1304).

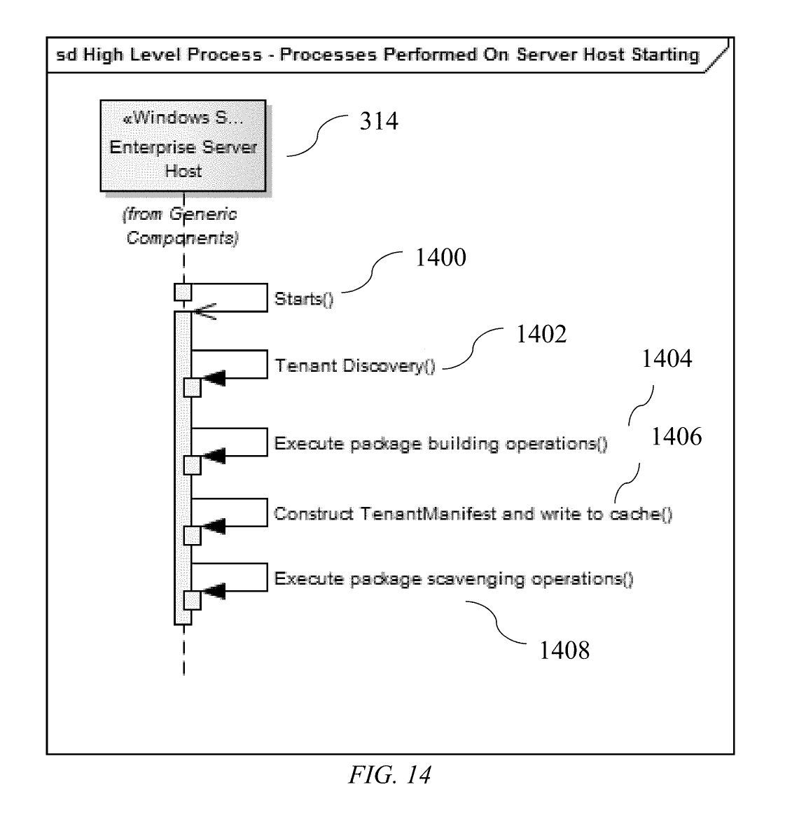

Referring now to FIG. 14, the Enterprise Server will be deployed into an active-active high availability group consisting of two or more nodes. Exactly one of the nodes in the high availability group will be designated as the Background Processes Server, performing operations beyond those involved in fulfilling requests from Channels.

When the Background Process Server Host starts up (1400), it must execute a series of operations to make all Enterprise Servers ready for their role in the enterprise synchronization capability. These steps include discovering (1402) Tenants 206 from Server Data by reading the Data Store 306 directly and obtaining a list of all active and inactive Tenants 206, and write to the cache, providing access to all Enterprise Servers. This process will remain ongoing via a Timer, and should be independently configurable. Active Tenants will be full participants in the system. For Inactive Tenants, Users will be denied authentication, Transport Packages 202 will be scavenged, and Transport Packages 202 will not be harvested.

Then Packages 202 are built (1404) from Server Data by creating Transport Packages 202 for all active Tenants 206 whose corresponding data has been added or updated since the server shut-down. This process will remain ongoing via a Timer, and should be independently configurable for each Package 202 type. Tenant Manifests 214 are built by creating a fresh Tenant Manifest 214 for each active Tenant 206 and write to the cache (1406), providing access to all Enterprise Servers. If needed, Scavenge Packages clean out any Transport Packages 202 that are no longer valid (1408) (For example, for inactive Tenants 206 packages should no longer be available). If needed, this process will remain ongoing via a Timer, and should be independently configurable. It is critical that each of these Background Server Process operations not run until any previous instances of that operation are completed. For example, the Tenant Discovery operation (1402) should not fire if an existing Tenant Discovery operation is still active.

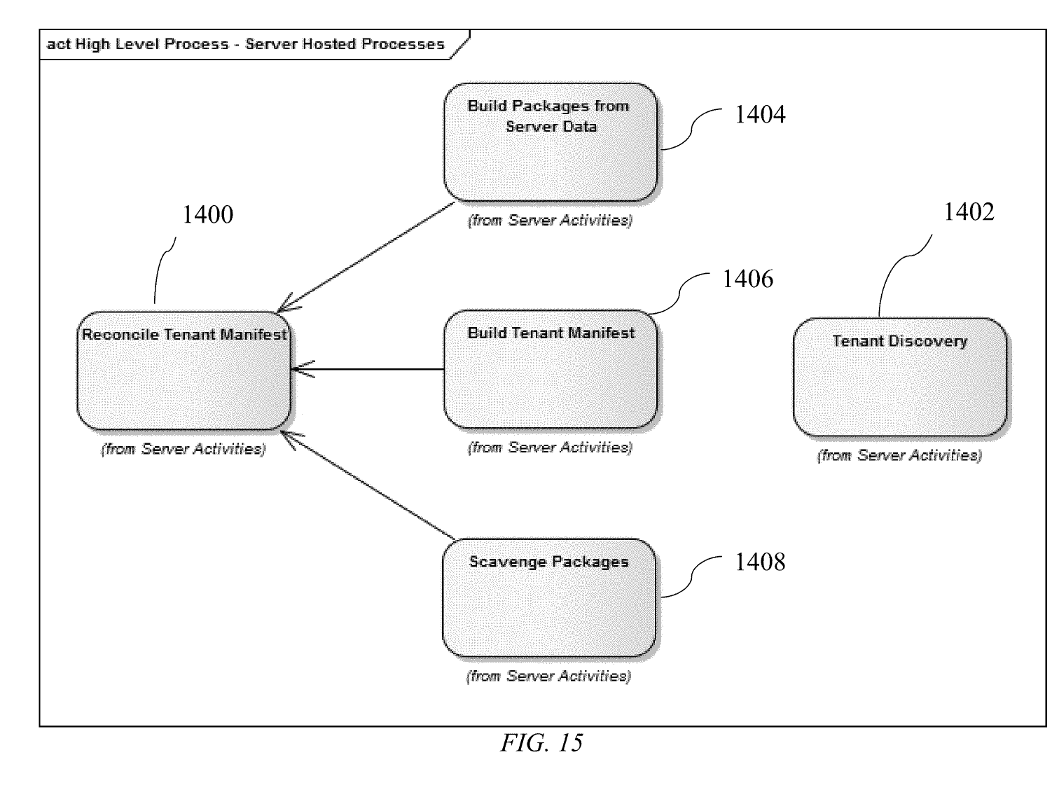

FIG. 15 illustrates the Server hosted processes of the computer-implement compliance system. After start-up, each of these operations is performed periodically, and/or operationally, during the normal course of operations on the server. Each of the server-based activities shown in Table 1 below should be independently configurable including enabled/disabled and periodic frequency (where applicable).

TABLE 1

| Operation | Performed When | Scale |
|---|---|---|
| Tenant Discovery | On Start-Up | Background |
| | Periodically (via | Process Server |
| | independent | |
| | configuration) | |
| PartialMasterData | On Start-Up | Background |
| Package Creation | Periodically (via | Process Server |
| | independent | |
| | configuration) | |
| PartialMasterChecklist | On Start-Up | Background |
| Package Creation | Periodically (via | Process Server |
| | independent | |
| | configuration) | |
| PartialDeletedChecklists | On Start-Up | Background |
| Package Creation | Periodically (via | Process Server |
| | independent | |
| | configuration) | |
| PartialChecklistInstance | On Start-Up | Background |
| Package Creation | Periodically (via | Process Server |
| | independent | |
| | configuration) | |
| AllMasterData Package | On Start-Up | Background |
| Creation | Periodically (via | Process Server |
| | independent | |
| | configuration) | |
| AllMasterChecklist | On Start-Up | Background |
| Package Creation | Periodically (via | Process Server |
| | independent | |
| | configuration) | |
| AllDeletedChecklists | On Start-Up | Background |
| Package Creation | Periodically (via | Process Server |
| | independent | |
| | configuration) | |
| AllChecklistInstance | On Start-Up | Background |
| Package Creation | Periodically (via | Process Server |
| | independent | |
| | configuration) | |
| Tenant Manifest creation | On Start-Up | Background |
| | | Process Server |
| Reconcile Tenant Manifest | On Harvest | Background |
| | On Scavenge | Process Server |
| | On Tenant Discovery | |
| Transport Package | On Start-Up (if needed) | Background |
| Scavenging | Once per day (if needed) | Process Server |

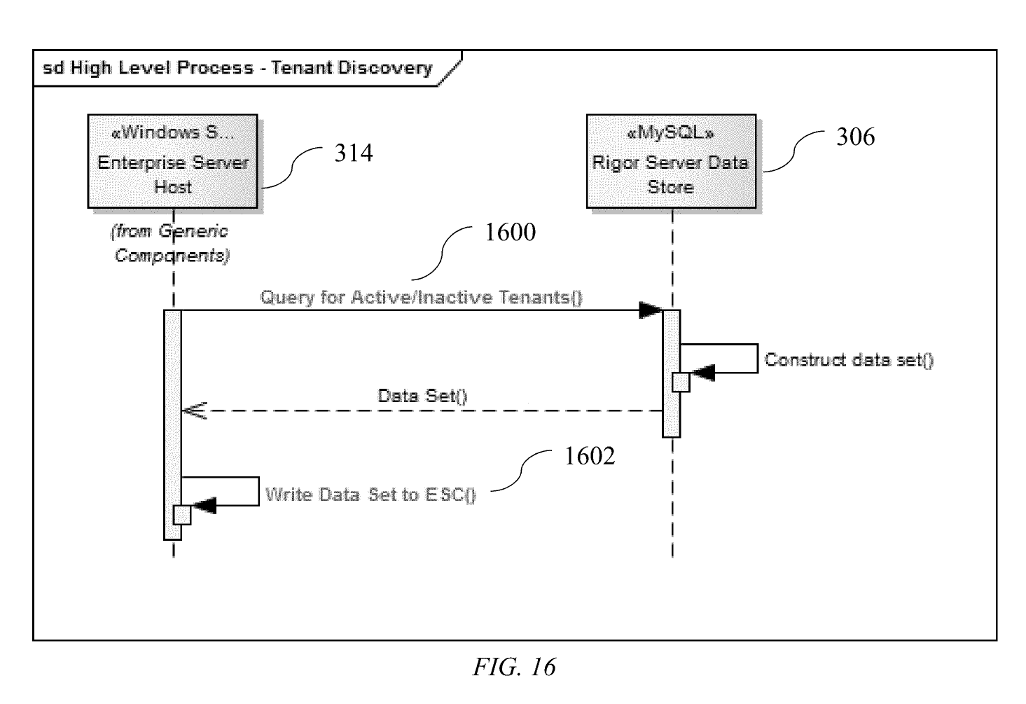

FIG. 16 illustrates the process of Tenant 206 discovery (1402), and when the Background Process Server starts-up, it will query the Data Store 306 directly to discover all of the active and inactive “Clients” (1600), which can be discerned from the “Master Database”. This list of Tenant's 206 will be written into the ESC 310 (1602), and used to govern building packages from server data, building/reconciling Tenant Manifests 214 and scavenging Transport Packages 202. Once the Background Process Server is up and running, this routine will be performed periodically, to account for Tenant's being removed, disabled, or created.

If Enterprise Server node is completely down, this operation will not execute. If the Data Store 306 was unavailable, the ES would not be able to harvest any Tenant 206 data. Make note of the issue in the event log, and operate as normal: keeping with the periodic harvesting. If the ESC 310 were unavailable, the ES would be unable to store the Tenant data in cache. Make note of the issue in the event log, and operate as normal: keeping with the periodic retrieval of Tenant data.

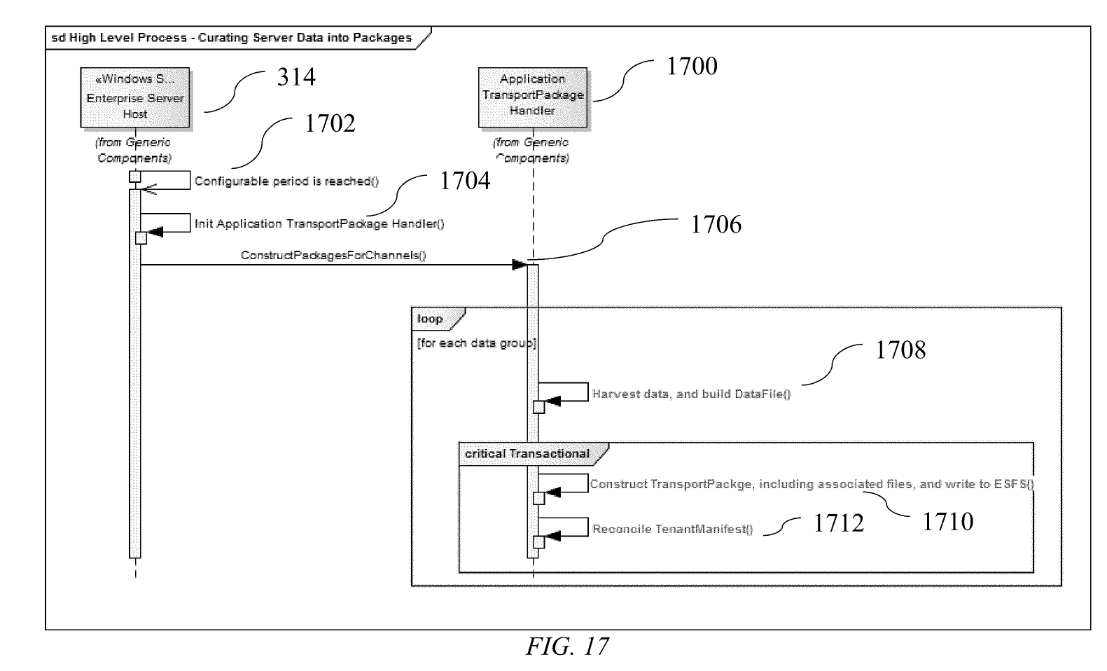

FIG. 17 illustrates the process steps of curating Server Data into Packages 202. Transport Packages 202 for sharing with Channels are constructed on the Background Process Server, using data harvested from the Data Store 306 via the Web API. The construction of Transport Packages 202 is initiated by the Background Process Server starting-up, as well as periodically afterwards. Alternatively, this mechanism can be implemented with an event published directly from the Web App/Web API.

If Enterprise Server node is completely down, this operation will not execute. If the API was unavailable, the ES would not be able to harvest any data, but will make note of the issue in the event log, and operate as normal: keeping with the periodic harvesting. If the ESFS were unavailable, the ES would be unable to persist the outgoing Transport Package, delete the Transport Package 202, make note of the issue in the event log, and operate as normal: keeping with the periodic harvesting. If the ESC 310 were unavailable, the ES would be unable reconcile the Tenant Manifest 214, the Transport Package 202 is deleted, make note of the issue in the event log, and operate as normal: keeping with the periodic harvesting.

On Start, and when the configurable period is reached (1702), the Background Process Server will execute (1704) the Application Transport Package Handler's 1700 “ConstructPackagesForChannels” method (1706) to achieve the following operations, according to Table 2 below.

TABLE 2

| PackageType Value | Action |
|---|---|
| PartialMasterData | Harvest all added or changed data for |
| | all Master Data objects changed since |
| | the last harvest. |
| PartialMasterChecklist | Harvest all added or changed data & |
| | files for all Master Checklists changed |
| | since the last harvest. One Transport |
| | Package per Master Checklist. |
| PartialDeletedChecklists | Harvest only references to the Master |
| | Checklists and Checklist Instances |
| | deleted since the last harvest. |
| PartialChecklistInstance | Harvest all added or changed data & |
| | files for all Checklist Instances changed |
| | since the last harvest. One Transport |
| | Package per Checklist Instance. |
| AllMasterData | Harvest all data for all Master Data |
| | objects |
| AllMasterChecklist | Harvest all data & files for all Master |
| | Checklists. One Transport Package per |
| | Master Checklist. |
| AllDeletedMasterChecklists | Harvest only references to all Master |
| | Checklists and Checklist Instances that |
| | have been deleted |
| AllChecklistInstance | Harvest data & files for all Checklist |
| | Instances. One Transport Package per |
| | Master Checklist. |

Data will be harvested from the Data Store 306, using appropriate methods from the existing Web API (1708). The Data File 212 will aggregate the data obtained from making distinct calls to the baseline Web API, making full reuse of the existing services, including their native business rules, and DML execution (1710). Unfortunately, this option also tightly couples the Package Handler to the API layer, but it does have several advantages including a) reuse of the Web API means we do not have to concern ourselves with replacing their business rules, or persistence function, and b) the time saved helps ensure our completion on-schedule.

Each Data File 212, and any associated Content Files 210, is placed into a Transport Package 202, and the Transport Package 202 is written to the ESFS 302 (1710), waiting for eventual transport to an iOS Channel. Once the Transport Package 202 is successfully written to the file store, the Data File 212 will be deleted, as it is no longer needed.

As each Transport Package 202 is written to the ESFS 302, the Tenant Manifest 214 should be reconciled to assure that it contains an item for the Transport Package 202 (1712). This operation must “lock” the manifest from being written to by other operators during this time, in order to manage contention. No duplicates should exist for the same Transport Package 202.

In the event that multiple Transport Packages 202 arrives for the same Checklist Instance 106 no reconciliation is planned. The server will process each Transport Package 202 in the order received. Therefore, a subsequent package may modify or delete data from a prior package. As the Channels receive the Transport Packages 202, they also will process each Transport Package 202 in the order they receive them. Therefore, a subsequent package may modify or delete data from a prior package.

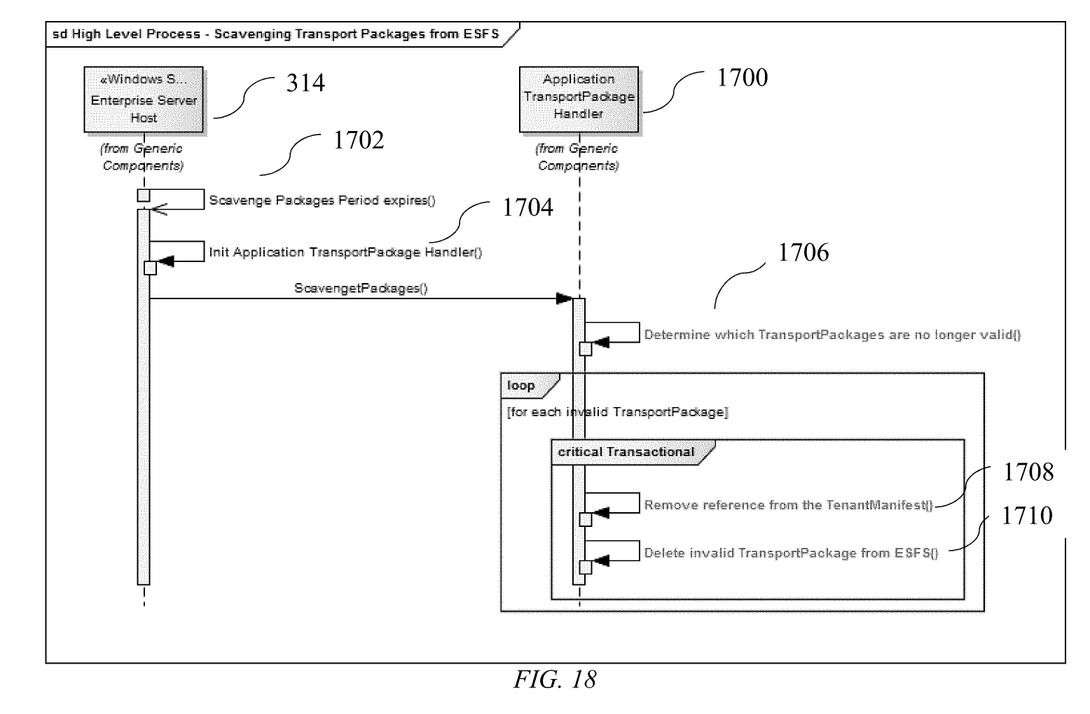

FIG. 18 illustrates the process steps of scavenging Transport Packages 202 from ESFS 302. If Enterprise Server node is completely down, this operation will not execute. If the ESFS 302 were unavailable, the ES would be unable to determine which Transport Packages 202 were available for scavenging, let alone delete them, and then notes the issue in the event log, and operates as normal: keeping with the periodic scavenging. If the ESC 310 were unavailable, the ES would be unable reconcile the Tenant Manifest 214, keep the Transport Package 202, make note of the issue in the event log, and operate as normal: keeping with the periodic scavenging.

Over time, Transport Packages 202 will build up on the Enterprise Server, eventually over-running the capacity to store them. Additionally, the number of items contained in the Tenant Manifest 214 will continue to grow unabated. To manage this uncontrolled growth, the Enterprise Server Host 314 will periodically (via configuration) (1702) examine the outgoing Transport Packages store (1704), and scavenge each Transport Package 202 that is no longer valid (1706), inside of a transaction that also includes removing its reference from the Tenant Manifest 214 (1708). This operation must “lock” the manifest from being written to by other operators during this time, in order to manage contention.

Any calls the iOS Channel makes to the Server, that are not being replaced by the target architecture Transport Package 202 design, will be made to a proxy on the Enterprise Server, which will forward the request to the method on the Server Web API.

To accomplish a full synchronization, the systems Transport Package 202 design is shown below in Tables 3-9.

TABLE 3
Distinct, Early Calls

| Baseline Call | Target Replacement |
|---|---|
| Post Local Deleted | Addressed by the uploaded Deleted_ |
| Assigned Checklists | ChecklistInstances TP, which puts |
| | references for all locally deleted checklist |
| | instances into one TP. |
| Get New Changes Count | Addressed by the downloaded Tenant |
| | Manifest, which contains a master list of |
| | all TP available for the Tenant the iOS |
| | Channel user belong to. Each Channel will |
| | determine for itself what from the manifest |
| | it needs. |
| Get All Incomplete | Made unnecessary by performing all |
| downloaded checklist | checklist sync in TPs containing all |
| from last sync | checklist data and files. Since all data and |
| | files are transported in packages, there |
| | should never be an incomplete download. |

Get Master Data Calls

| Baseline Call | Target Replacement |
|---|---|
| Get Users | Addressed by the downloaded |
| Get Department | AllMasterData (first time syncs) and |
| Get Hazard Icons | PartialMasterData (subsequent syncs) TPs. |
| Get Groups | |
| Get Tags | |
| Get User Favorites | |
| Get Group Tag Relations | |
| Get All Master Checklists | Addressed by the downloaded |
| (Without elements) | AllMasterChecklist (first time syncs) and |
| | PartialMasterChecklist (subsequent syncs) |
| | TPs |
| Get Active Assigned | Addressed by the downloaded |
| Checklists (without | ChecklistInstance TPs building up on the |
| elements) | server. These are originally created on the |
| | iOS Channels, collected on the server, then |
| | redistributed back to the other Channels. |
| | This only works because all assigned |
| | checklists are expected to be on every |
| | Channel. |
| Get all deleted assigned | Addressed by the downloaded |
| checklists | AllDeletedMasterChecklists (first time |
| | syncs) and PartialDeletedMasterChecklists |
| | (subsequent syncs)s |

TABLE 5
Get (Master) Checklist Elements

| Baseline Call | Target Replacement |
|---|---|
| Get Checklist Groups | Addressed by the |
| Get Checklist Logos | downloaded |
| Get Checklist PPEs | AllMasterChecklist |
| Get Checklist Text | (first time syncs) and |
| Get Checklist Decisions | PartialMasterChecklist |
| Get Checklist Notes | (subsequent syncs) TPs |
| Get Checklist Note Risks | |
| Get Checklist Note Hazards | |
| Get Checklist Warnings | |
| Get Checklist Warning Risks | |
| Get Checklist Warning Hazards | |
| Get Checklist Cautions | |
| Get Checklist Caution Risks | |
| Get Checklist Caution Hazards | |
| Get Checklist Steps | |
| Get Checklist Step Attributes | |
| Get Checklist Step Result Functions | |
| Get Checklist Step Prerequisites | |
| Get Checklist Step Resources | |
| Get Checklist Embedded Resources | |
| Get Checklist Survey Questions | |
| Get Checklist Survey Question Options | |

TABLE 6
Get (Assigned) Checklist Instance Elements

| Baseline Call | Target Replacement |
|---|---|
| Get Assigned Checklist Logos | Addressed by the |
| Get Assigned Checklist Users | downloaded |
| Get Assigned Checklist Decisions | ChecklistInstance TPs |
| Get Assigned Checklist Notes | building up on the server. |
| Get Assigned Checklist Warnings | These are originally created |
| Get Assigned Checklist Cautions | on the iOS Channels, |
| Get Assigned Checklist Tags | collected on the server, |
| Get Assigned Checklist Steps | then redistributed back to |
| Get Assigned Checklist Step Users | the other Channels. This |
| Get Assigned Checklist Step QAs | only works because all |
| Get Assigned Checklist Step Results | assigned checklists are |
| Get Assigned Checklist Step Resources | expected to be on every |
| Get Assigned Checklist Pause Time | Channel. |
| Get Assigned Checklist Item Notes | |
| Get Assigned Checklist Survey Question | |
| Options | |
| Get Assigned Checklist Item Barcodes | |
| Get Checklist History | Not sure what this is. Need |
| | to learn!! |

TABLE 7
Download Checklist Resources Process

| Baseline Call | Target Replacement |
|---|---|
| Download Checklist Embedded Resources | Addressed by the |
| Download Favorite Checklist Resources | downloaded |
| | AllMasterChecklists (first |
| | time syncs) and |
| | PartialMasterChecklists |
| | (subsequent syncs) TPs |

TABLE 8
Post Channel Data

| Baseline Call | Target Replacement |
|---|---|
| Post Assigned Checklist Logo | Addressed by the uploaded |
| Post Assigned Checklist Users | ChecklistInstance TPs |
| Post Assigned Decisions | building up on the server. |
| Post Assigned Notes | These are originally created |
| Post Assigned Warnings | on the iOS Channels, |
| Post Assigned Cautions | collected on the server, then |
| Post Assigned Checklist Tags | redistributed back to the |
| Post Assigned Steps | other Channels. This only |
| Post Assigned Checklist Step Users | works because all assigned |
| Post Assigned Checklist Step QAs | checklists are expected to |
| Post Assigned Checklist Step Results | be on every Channel. |
| Functions | |
| Post Updated Assigned Checklist Step | |
| Resources Data | |
| Post Assigned Checklist Pause Time | |
| Post Assigned Item Notes | |
| Post Assigned Checklist Survey Question | |
| Options | |
| Post Assigned Checklist Item Barcodes | |
| Post User Favorites | |
| Post Assigned Checklists | |
| Post Suggestions | |
| Post Assigned Checklist History | |

TABLE 9
Upload Assigned Checklist Instance Step Resources

| Baseline Call | Target Replacement |
|---|---|
| Upload Assigned | Addressed by the uploaded ChecklistInstance |
| Checklist Instance | TPs building up on the server. These are |
| Step Resources | originally created on the iOS Channels, |
| | collected on the server, then redistributed back |
| | to the other Channels. This only works because |
| | all assigned checklists are expected to be on |
| | every Channel. |

The computer-implemented methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as .NET and C++, a lightweight data-interchange programming language such as JavaScript Object Notation (JSON) data-interchange format over HTTP POST request/response, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the method to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the instant disclosure may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A computer-implemented compliance system for facilitation of procedural compliance with critical tasks leading to operational reliability, said system comprising a computer coupled for inter-communication to a plurality of stations from which respective users each have a browser-based interface with the computer, said computer further comprising:
an interactive checklist configured to capture operational data at the time and place of task performance, said interactive checklist having a layered architecture comprising an enterprise server host, an enterprise services host, an enterprise manager, a provider, and a plurality of shared persistence stores; said interactive checklist further comprising primary domain objects and transport domain objects.

2. The system of claim 1 wherein said shared persistence stores comprises an application data store, an application file store, an enterprise server file store, and an enterprise server event sink.

3. The system of claim 2 wherein said primary domain objects comprise a master checklist, a checklist instance, and a step or multiple steps with associated notes, cautions, warnings, and embedded and attached digital resource files to support reliable task performance.

4. The system of claim 3 wherein said interactive checklist comprises granular data on outcomes to develop impactful process improvements.

5. The system of claim 3 wherein said interactive checklist comprises an acknowledgement of a note, warning, or caution before completing a step.

6. The system of claim 4 wherein said granular data comprises minimum critical information and steps to act as a crosscheck.

7. The system of claim 3 wherein said checklist instance is a copy of said master checklist.

8. The system of claim 3 wherein said transport domain objects comprise a transport package, a data file, a file content, a tenant manifest, and a tenant.

9. The system of claim 8 wherein said transport package comprises said data file, a plurality of said file contents, said master checklist, and said checklist instance.

10. The system of claim 9 wherein said file content comprises said step or said multiple steps with associated said notes, cautions, warnings, and embedded and attached digital resource files to support reliable task performance.

11. The system of claim 9 further comprising an application transport package handler in inter-communication with said enterprise server host and configured to process incoming transport packages.

12. The system of claim 11 wherein each of said data files and any associated content files are synchronously or asynchronously stored in a corresponding transport package, and wherein said transport package stored on said enterprise services host is a whole transport package or an aggregate transport package.

13. A computer-readable medium having computer-readable instructions for performing a method for facilitation of procedural compliance with critical tasks leading to operational reliability using an automated computer-based compliance system, said compliance system comprising a enterprise server in inter-communication with browser-enabled user devices, said method comprising the steps of:
providing said user devices access to said compliance system;
facilitating procedural compliance by electronically capturing operational data at a time and place of task performance with said user devices using an interactive checklist; and
synchronously or asynchronously storing said operational data on said enterprise server.

14. The method of claim 13 wherein said step of facilitating procedural compliance further comprises the steps of critically assessing performance efficiency, developing baseline trends, identifying areas for improvement, assessing quality, measuring an impact of process improvements, or a combination thereof.

15. The method of claim 14 further comprising the steps of:
qualifying and/or quantifying all work stoppages; and
reporting temporal performance in multiple granular data formats so that said baseline trends and said performance efficiency are accurately assessed.

16. The method of claim 14 further comprising the step of providing an acknowledgement of a note, warning, or caution before completing a step.

17. The method of claim 14 further comprising the step of accurately assessing individual step time to complete, individual and total pause time with associated reason(s), total checklists time to complete, total checklist operation time, or a combination thereof.

18. The method of claim 13 further comprising the steps of:
compiling said operational data into a transport package;
synchronously or asynchronously storing said transport package on said enterprise server as a complete transport package or an aggregate transport package.

19. The method of claim 18 further comprising the step of verifying said complete transport package using a checksum on said enterprise server.

20. The method of claim 19 further comprising the step of sending an acknowledgement comprising an enterprise server generated tracking number and time stamp of when said complete transport package was stored on said enterprise server.
